(19) United States
(12) Patent Application Publication
(10) Pub. No.: US 2026/0261410 A1
(43) Pub. Date: Sep. 3, 2026

(54) METHOD FOR SINGLE-PHOTON PAIR-BASED ONE-WAY AND ONE-STEP QUANTUM DIRECT COMMUNICATION, AND DEVICE THEREFOR

(71) Applicant: LG ELECTRONICS INC., Seoul (KR)

(72) Inventors: Byungkyu AHN, Seoul (KR); Sangrim LEE, Seoul (KR); Hojae LEE, Seoul (KR); Jayeong KIM, Seoul (KR)

(21) Appl. No.: 18/873,112

(22) PCT Filed: Jun. 10, 2022
(86) PCT No.: PCT/KR2022/008237

§ 371 Date: Dec. 9, 2024

(51) Int. Cl. H04L 9/08

(52) U.S. Cl. CPC H04L 9/0858

(57) ABSTRACT

The present disclosure provides a method for a transmitting terminal to transmit information on a quantum channel in a quantum communication system. More specifically, the method comprises generating a single photon pair related to a polarization coding for transmission of the information; generating a transmission information sequence including (i) a message sequence related to the information and (ii) a checking sequence related to a quantum bit error rate (QBER) estimation for determining whether there is eavesdropping on a quantum channel, the checking sequence being randomly inserted between sequence elements of the message sequence; performing either (i) an encryption or (ii) a scrambling on the information sequence; transmitting, to a receiving terminal, quantum information generated based on the polarization coding for the information sequence, to which either (i) the encryption or (ii) the scrambling is applied, on the quantum channel; performing the QBER estimation with the receiving terminal; and transmitting, to the receiving terminal, information for restoring the information sequence, to which either (i) the encryption or (ii) the scrambling is applied, based on a result of the QBER estimation.

### CROSS-REFERENCE TO RELATED APPLICATIONS

This application is the National Stage filing under 35 U.S.C. 371 of International Application No. PCT/KR2022/008237, filed on Jun. 10, 2022, the contents of which are all hereby incorporated by reference herein in their entirety.

### TECHNICAL FIELD

The present disclosure relates to a quantum communication system, and more particularly to a method and device for transmitting information through single-photon pair based one-way and one-step transmission in a quantum direct communication system.

### BACKGROUND ART

Wireless communication systems are widely deployed to provide various types of communication services, such as voice and data. In general, the wireless communication system is a multiple access system capable of supporting communication with multiple users by sharing available system resources (bandwidth, transmission power, etc.). Examples of the multiple access system include a Code Division Multiple Access (CDMA) system, a Frequency Division Multiple Access (FDMA) system, a Time Division Multiple Access (TDMA) system, a Space Division Multiple Access (SDMA) system, an Orthogonal Frequency Division Multiple Access (OFDMA) system, a Single Carrier Frequency Division Multiple Access (SC-FDMA) system, and an Interleave Division Multiple Access (IDMA) system. In addition, research is ongoing on quantum communication, which is a next-generation communication technology that can overcome the limitations of existing information and communication, such as security and ultra-fast computation, by applying quantum mechanical properties to the information and communication field. The quantum communication provides a means to generate, transmit, process, and store information in the form that cannot be expressed or is difficult to express in the form of 0 and 1 according to binary bit information used in existing communication technologies. In the existing communication technologies, wavelengths, amplitudes, or the like have been used for information transmission between a transmitting terminal and a receiving terminal, but in the quantum communication, a photon, which is the smallest unit of light, is used for the information transmission between the transmitting terminal and the receiving terminal.

### Technical Problem

An object of the present disclosure is to provide a method of transmitting information in a quantum direct communication system, and a device therefor.

Another object of the present disclosure is to provide a method of minimizing a distance loss of up to four times an actual channel length caused by the structural form of a quantum direct communication system, and a device therefor.

Another object of the present disclosure is to provide a method for achieving both quantum bit error rate (QBER) estimation and message information transmission through one-way and one-step transmission in a quantum direct communication system, and a device therefor.

Another object of the present disclosure is to provide a method for generating and transmitting quantum information by randomly combining message information and information for QBER estimation in a quantum direct communication system, and a device therefor.

Another object of the present disclosure is to provide a method for scrambling or encrypting message information in one-way and one-step transmission in a quantum direct communication system, and a device therefor.

The technical objects to be achieved by the present disclosure are not limited to those that have been described hereinabove merely by way of example, and other technical objects that are not mentioned can be clearly understood by those skilled in the art, to which the present disclosure pertains, from the following descriptions.

### Solution to Problem

The present disclosure provides a method of transmitting information in a quantum direct communication system and a device therefor.

More specifically, in one aspect of the present disclosure, there is provided a method of transmitting, by a transmitting terminal, information in a quantum communication system comprising generating a single photon pair related to a polarization coding for transmission of the information; generating a transmission information sequence including (i) a message sequence related to the information and (ii) a checking sequence related to a quantum bit error rate (QBER) estimation for determining whether there is eavesdropping on a quantum channel, wherein the checking sequence is randomly inserted between sequence elements of the message sequence; performing either (i) an encryption or (ii) a scrambling on the information sequence; transmitting, to a receiving terminal, quantum information generated based on the polarization coding for the information sequence, to which either (i) the encryption or (ii) the scrambling is applied, on the quantum channel; performing the QBER estimation with the receiving terminal; and transmitting, to the receiving terminal, information for restoring the information sequence, to which either (i) the encryption or (ii) the scrambling is applied, based on a result of the QBER estimation.

Based on a value of the result of the QBER estimation being greater than or equal to a specific value, the information for restoring the information sequence may not be transmitted.

Based on a value of the result of the QBER estimation being less than a specific value, the information for restoring the information sequence may be transmitted.

The scrambling may be performed through an XOR operation between the information sequence and a sequence generated from a random number generator.

Based on the scrambling being applied to the information sequence, the information for restoring the information sequence may include information for the sequence generated from the random number generator.

Based on the scrambling being applied to the information sequence, the information sequence to which the scrambling is applied may be restored through an XOR operation between a sequence measured at the receiving terminal and a sequence included in the information for the sequence generated from the random number generator.

The encryption may be performed based on (i) a symmetric key pre-shared between the transmitting terminal and the receiving terminal and (ii) a round key configured to only the transmitting terminal.

Based on the encryption being applied to the information sequence, the information for restoring the information sequence may include information on the round key.

Based on the encryption being applied to the information sequence, the information sequence to which the encryption is applied may be restored by performing a reverse process of the encryption performed by the transmitting terminal through the information on the round key with respect to a sequence measured at the receiving terminal.

Different polarization codings may be used for (i) the message sequence related to the information and (ii) the checking sequence related to the QBER estimation.

The polarization coding used for the message sequence related to the information may be performed based on different two types of basises and different four types of single photon pairs. Each of the two types of basises may be constructed based on two types of single photons classified based on an angle that a single photon has. Each of the four types of single photon pairs may include (i) the same type of basis and (ii) the same type of two single photons among two types of single photons constituting the same type of basis.

The polarization coding used for the checking sequence related to the QBER estimation may be performed based on different two types of basises and different 16 types of single photon pairs. Each of the two types of basises may be constructed based on two types of single photons classified based on an angle that a single photon has. The 16 types of single photon pairs may include (a) (i) the same type of basis and (ii) four single photon pairs including the same type of two single photons among two types of single photons constituting the same type of basis, and (b) (i) the same type of basis and (ii) four single photon pairs including different types of two single photons among two types of single photons constituting the same type of basis.

The 16 types of single photon pairs may further include eight single photon pairs including two single photons included in different types of basises.

Based on types of two single photons constituting each of two single photon pairs being the same, and an order of including the two single photons in each of the two single photon pairs being different in the two single photon pairs, the two single photon pairs may be different single photon pairs.

In another aspect of the present disclosure, there is provided a transmitting terminal transmitting information in a quantum communication system comprising a transmitter configured to transmit a radio signal; a receiver configured to receive the radio signal; at least one processor; and at least one computer memory operably connectable to the at least one processor and configured to store instructions performing operations based on being executed by the at least one processor, wherein the operations comprise generating a single photon pair related to a polarization coding for transmission of the information; generating a transmission information sequence including (i) a message sequence related to the information and (ii) a checking sequence related to a quantum bit error rate (QBER) estimation for determining whether there is eavesdropping on a quantum channel, wherein the checking sequence is randomly inserted between sequence elements of the message sequence; performing either (i) an encryption or (ii) a scrambling on the information sequence; transmitting, to a receiving terminal, quantum information generated based on the polarization coding for the information sequence, to which either (i) the encryption or (ii) the scrambling is applied, on the quantum channel; performing the QBER estimation with the receiving terminal; and transmitting, to the receiving terminal, information for restoring the information sequence, to which either (i) the encryption or (ii) the scrambling is applied, based on a result of the QBER estimation.

In another aspect of the present disclosure, there is provided a method of receiving, by a receiving terminal, information in a quantum communication system comprising receiving, from a transmitting terminal, a single photon pair including quantum information generated based on a polarization coding for an information sequence, to which either (i) an encryption or (ii) a scrambling is applied, on a quantum channel through a basis pair including different basises, wherein the polarization coding is performed based on the single photon pair for the polarization coding, wherein the information sequence includes (i) a message sequence related to the information and (ii) a checking sequence related to a quantum bit error rate (QBER) estimation for determining whether there is eavesdropping on the quantum channel, wherein the checking sequence is randomly inserted between sequence elements of the message sequence; performing the QBER estimation with the transmitting terminal; and receiving, from the transmitting terminal, information for restoring the information sequence, to which either (i) the encryption or (ii) the scrambling is applied, based on a result of the QBER estimation.

In another aspect of the present disclosure, there is provided a receiving terminal receiving information in a quantum communication system comprising a transmitter configured to transmit a radio signal; a receiver configured to receive the radio signal; at least one processor; and at least one computer memory operably connectable to the at least one processor and configured to store instructions performing operations based on being executed by the at least one processor, wherein the operations comprise receiving, from a transmitting terminal, a single photon pair including quantum information generated based on a polarization coding for an information sequence, to which either (i) an encryption or (ii) a scrambling is applied, on a quantum channel through a basis pair including different basises, wherein the polarization coding is performed based on the single photon pair for the polarization coding, wherein the information sequence includes (i) a message sequence related to the information and (ii) a checking sequence related to a quantum bit error rate (QBER) estimation for determining whether there is eavesdropping on the quantum channel, wherein the checking sequence is randomly inserted between sequence elements of the message sequence; performing the QBER estimation with the transmitting terminal; and receiving, from the transmitting terminal, information for restoring the information sequence, to which either (i) the encryption or (ii) the scrambling is applied, based on a result of the QBER estimation.

In another aspect of the present disclosure, there is provided a non-transitory computer readable medium (CRM) storing one or more instructions, wherein the one or more instructions executable by one or more processors are configured to allow a transmitting terminal to generate a single photon pair related to a polarization coding for transmission of information; generate a transmission information sequence including (i) a message sequence related to the information and (ii) a checking sequence related to a quantum bit error rate (QBER) estimation for determining whether there is eavesdropping on a quantum channel, wherein the checking sequence is randomly inserted between sequence elements of the message sequence; perform either (i) an encryption or (ii) a scrambling on the information sequence; transmit, to a receiving terminal, quantum information generated based on the polarization coding for the information sequence, to which either (i) the encryption or (ii) the scrambling is applied, on the quantum channel; perform the QBER estimation with the receiving terminal; and transmit, to the receiving terminal, information for restoring the information sequence, to which either (i) the encryption or (ii) the scrambling is applied, based on a result of the QBER estimation.

In another aspect of the present disclosure, there is provided a device comprising one or more memories; and one or more processors operably connected to the one or more memories, wherein the one or more processors are configured to allow the device to generate a single photon pair related to a polarization coding for transmission of information; generate a transmission information sequence including (i) a message sequence related to the information and (ii) a checking sequence related to a quantum bit error rate (QBER) estimation for determining whether there is eavesdropping on a quantum channel, wherein the checking sequence is randomly inserted between sequence elements of the message sequence; perform either (i) an encryption or (ii) a scrambling on the information sequence; transmit, to a receiving terminal, quantum information generated based on the polarization coding for the information sequence, to which either (i) the encryption or (ii) the scrambling is applied, on the quantum channel; perform the QBER estimation with the receiving terminal; and transmit, to the receiving terminal, information for restoring the information sequence, to which either (i) the encryption or (ii) the scrambling is applied, based on a result of the QBER estimation.

### Advantageous Effects of Invention

The present disclosure has an effect of transmitting information in a quantum direct communication system.

The present disclosure also has an effect of minimizing a distance loss of up to four times an actual channel length caused by the structural form of a quantum direct communication system.

The present disclosure also has an effect of achieving both quantum bit error rate (QBER) estimation and message information transmission through one-way and one-step transmission in a quantum direct communication system.

The present disclosure also has an effect of preventing an eavesdropper from eavesdropping on message information by avoiding only bits for QBER estimation of quantum information transmitted on a quantum channel in a quantum direct communication system.

The present disclosure also has an effect that an eavesdropper cannot understand actual message information even if the eavesdropper eavesdrops on quantum information transmitted on a quantum channel in a quantum direct communication system.

Effects that could be achieved with the present disclosure are not limited to those that have been described hereinabove merely by way of example, and other effects and advantages of the present disclosure will be more clearly understood from the following description by a person skilled in the art to which the present disclosure pertains.

### BRIEF DESCRIPTION OF DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 illustrates an example of a communication system applicable to the present disclosure.

FIG. 2 illustrates an example of a wireless apparatus applicable to the present disclosure.

FIG. 3 illustrates a method of processing a transmitted signal applicable to the present disclosure.

FIG. 4 illustrates another example of a wireless device applicable to the present disclosure.

FIG. 5 illustrates an example of a hand-held device applicable to the present disclosure.

FIG. 6 illustrates physical channels applicable to the present disclosure and a signal transmission method using the same.

FIG. 7 illustrates the structure of a radio frame applicable to the present disclosure.

FIG. 8 illustrates a slot structure applicable to the present disclosure.

FIG. 9 illustrates an example of a communication structure providable in a 6G system applicable to the present disclosure.

FIG. 10 illustrates overall configuration of DL04 QSDC protocol.

FIG. 11 illustrates an example of an information transmission method in a two-step QSDC protocol.

FIG. 12 is a flowchart illustrating an example of an overall performance process of a method described in the present disclosure.

FIG. 13 illustrates an example of a process in which a hybrid sequence is generated through a process for signal generation performed in a signal generation unit of a transmitting terminal, and scrambling/encryption is applied to the generated hybrid sequence.

FIG. 14 illustrates a polarization coding rule of a single photon pair based on classical message information.

FIG. 15 illustrates an example of a measurement basis pair used for measurement of a single photon pair.

FIG. 16 illustrates an example of a security enhancement method of message information through AES based encryption.

FIG. 17 illustrates an example of a photon pair combination defined for polarization coding for a checking sequence for QBER estimation.

FIG. 18 illustrates an overall configuration of a single-photon pair based QDC protocol with a parallel structure.

FIG. 19 illustrates an example of device configuration for implementing a one-way and one-step QDC method based on a parallel structure.

FIG. 20 illustrates another example of device configuration for implementing a one-way and one-step QDC method based on a parallel structure.

FIG. 21 illustrates an overall configuration of a single-photon pair based QDC protocol with a serial structure.

FIG. 22 illustrates an example of device configuration for implementing a one-way and one-step QDC method based on a serial structure.

FIG. 23 illustrates another example of device configuration for implementing a one-way and one-step QDC method based on a serial structure.

FIG. 24 illustrates expected effects in a QDC method described in the present disclosure.

FIG. 25 is a flowchart illustrating an example in which a method of transmitting information in a quantum communication system described in the present disclosure is performed by a transmitting terminal.

FIG. 26 is a flowchart illustrating an example in which a method of transmitting information in a quantum communication system described in the present disclosure is performed by a receiving terminal.

### MODE FOR INVENTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a Base Station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an Advanced Base Station (ABS), an access point, etc.

In the embodiments of the present disclosure, the term terminal may be replaced with a UE, a Mobile Station (MS), a Subscriber Station (SS), a Mobile Subscriber Station (MSS), a mobile terminal, an Advanced Mobile Station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an UpLink (UL). Likewise, the mobile station may serve as a receiver and the BS may serve as a transmitter, on a DownLink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.xxx.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

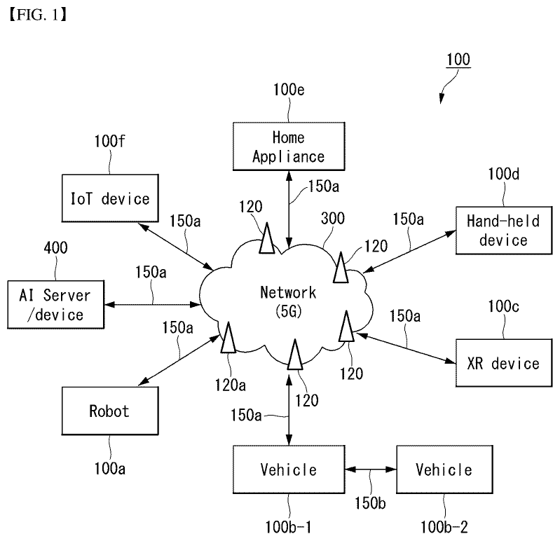

FIG. 1 illustrates an example of a communication system applicable to the present disclosure. Referring to FIG. 1, the communication system 100 applicable to the present disclosure includes a wireless device, a base station and a network. The wireless device refers to a device for performing communication using radio access technology (e.g., 5G NR or LTE) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network or a 5G (e.g., NR) network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b and 150c may be established between the wireless devices 100a to 100f/the base station 120 and the base station 120/the base station 120. Here, wireless communication/connection may be established through various radio access technologies (e.g., 5G NR) such as uplink/downlink communication 150a, sidelink communication 150b (or D2D communication) or communication 150c between base stations (e.g., relay, integrated access backhaul (IAB). The wireless device and the base station/wireless device or the base station and the base station may transmit/receive radio signals to/from each other through wireless communication/connection 150a, 150b and 150c. For example, wireless communication/connection 150a, 150b and 150c may enable signal transmission/reception through various physical channels. To this end, based on the various proposals of the present disclosure, at least some of various configuration information setting processes for transmission/reception of radio signals, various signal processing procedures (e.g., channel encoding/decoding, modulation/demodulation, resource mapping/demapping, etc.), resource allocation processes, etc. may be performed.

Communication system applicable to the present disclosure

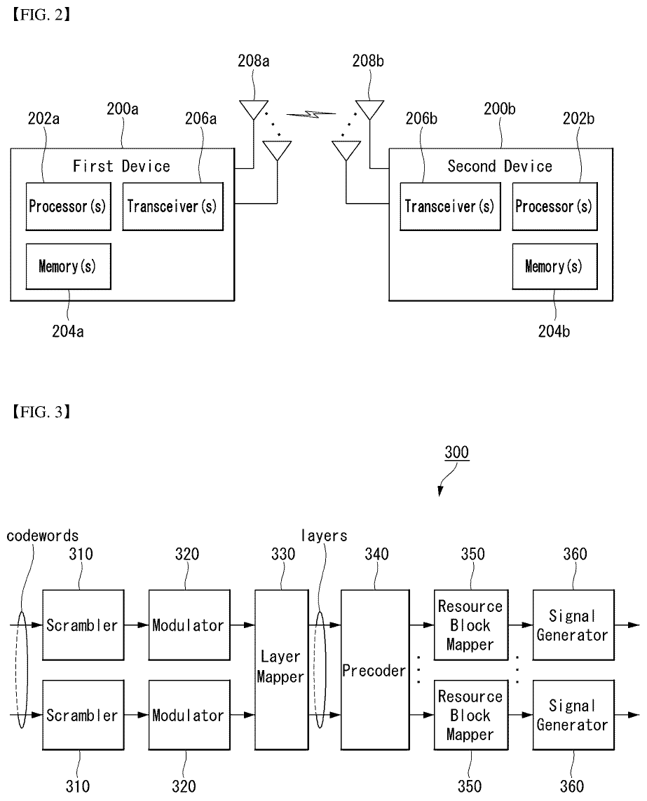

FIG. 2 illustrates an example of a wireless device applicable to the present disclosure.

Referring to FIG. 2, a first wireless device 200a and a second wireless device 200b may transmit and receive radio signals through various radio access technologies (e.g., LTE or NR). Here, {the first wireless device 200a, the second wireless device 200b} may correspond to {the wireless device 100x, the base station 120} and/or {the wireless device 100x, the wireless device 100x} of FIG. 1.

The first wireless device 200a may include one or more processors 202a and one or more memories 204a and may further include one or more transceivers 206a and/or one or more antennas 208a. The processor 202a may be configured to control the memory 204a and/or the transceiver 206a and to implement descriptions, functions, procedures, proposals, methods and/or operational flowcharts disclosed herein. For example, the processor 202a may process information in the memory 204a to generate first information/signal and then transmit a radio signal including the first information/signal through the transceiver 206a. In addition, the processor 202a may receive a radio signal including second information/signal through the transceiver 206a and then store information obtained from signal processing of the second information/signal in the memory 204a. The memory 204a may be connected with the processor 202a, and store a variety of information related to operation of the processor 202a. For example, the memory 204a may store software code including instructions for performing all or some of the processes controlled by the processor 202a or performing the descriptions, functions, procedures, proposals, methods and/or operational flowcharts disclosed herein. Here, the processor 202a and the memory 204a may be part of a communication modem/circuit/chip designed to implement wireless communication technology (e.g., LTE or NR). The transceiver 206a may be connected with the processor 202a to transmit and/or receive radio signals through one or more antennas 208a. The transceiver 206a may include a transmitter and/or a receiver. The transceiver 206a may be used interchangeably with a radio frequency (RF) unit. In the present disclosure, the wireless device may refer to a communication modem/circuit/chip.

The second wireless device 200b may include one or more processors 202b and one or more memories 204b and may further include one or more transceivers 206b and/or one or more antennas 208b. The processor 202b may be configured to control the memory 204b and/or the transceiver 206b and to implement the descriptions, functions, procedures, proposals, methods and/or operational flowcharts disclosed herein. For example, the processor 202b may process information in the memory 204b to generate third information/signal and then transmit the third information/signal through the transceiver 206b. In addition, the processor 202b may receive a radio signal including fourth information/signal through the transceiver 206b and then store information obtained from signal processing of the fourth information/signal in the memory 204b. The memory 204b may be connected with the processor 202b to store a variety of information related to operation of the processor 202b. For example, the memory 204b may store software code including instructions for performing all or some of the processes controlled by the processor 202b or performing the descriptions, functions, procedures, proposals, methods and/or operational flowcharts disclosed herein. Herein, the processor 202b and the memory 204b may be part of a communication modem/circuit/chip designed to implement wireless communication technology (e.g., LTE or NR). The transceiver 206b may be connected with the processor 202b to transmit and/or receive radio signals through one or more antennas 208b. The transceiver 206b may include a transmitter and/or a receiver. The transceiver 206b may be used interchangeably with a radio frequency (RF) unit. In the present disclosure, the wireless device may refer to a communication modem/circuit/chip.

Hereinafter, hardware elements of the wireless devices 200a and 200b will be described in greater detail. Without being limited thereto, one or more protocol layers may be implemented by one or more processors 202a and 202b. For example, one or more processors 202a and 202b may implement one or more layers (e.g., functional layers such as PHY (physical), MAC (media access control), RLC (radio link control), PDCP (packet data convergence protocol), RRC (radio resource control), SDAP (service data adaptation protocol)). One or more processors 202a and 202b may generate one or more protocol data units (PDUs) and/or one or more service data unit (SDU) according to the descriptions, functions, procedures, proposals, methods and/or operational flowcharts disclosed herein. One or more processors 202a and 202b may generate messages, control information, data or information according to the descriptions, functions, procedures, proposals, methods and/or operational flowcharts disclosed herein. One or more processors 202a and 202b may generate PDUs, SDUs, messages, control information, data or information according to the functions, procedures, proposals and/or methods disclosed herein and provide the PDUs, SDUs, messages, control information, data or information to one or more transceivers 206a and 206b. One or more processors 202a and 202b may receive signals (e.g., baseband signals) from one or more transceivers 206a and 206b and acquire PDUs, SDUs, messages, control information, data or information according to the descriptions, functions, procedures, proposals, methods and/or operational flowcharts disclosed herein.

One or more processors 202a and 202b may be referred to as controllers, microcontrollers, microprocessors or microcomputers. One or more processors 202a and 202b may be implemented by hardware, firmware, software or a combination thereof. For example, one or more application specific integrated circuits (ASICs), one or more digital signal processors (DSPs), one or more digital signal processing devices (DSPDs), programmable logic devices (PLDs) or one or more field programmable gate arrays (FPGAs) may be included in one or more processors 202a and 202b. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in one or more processors 202a and 202b or stored in one or more memories 204a and 204b to be driven by one or more processors 202a and 202b. The descriptions, functions, procedures, proposals, methods and/or operational flowcharts disclosed herein implemented using firmware or software in the form of code, a command and/or a set of commands.

One or more memories 204a and 204b may be connected with one or more processors 202a and 202b to store various types of data, signals, messages, information, programs, code, instructions and/or commands. One or more memories 204a and 204b may be composed of read only memories (ROMs), random access memories (RAMs), erasable programmable read only memories (EPROMs), flash memories, hard drives, registers, cache memories, computer-readable storage mediums and/or combinations thereof. One or more memories 204a and 204b may be located inside and/or outside one or more processors 202a and 202b. In addition, one or more memories 204a and 204b may be connected with one or more processors 202a and 202b through various technologies such as wired or wireless connection.

One or more transceivers 206a and 206b may transmit user data, control information, radio signals/channels, etc. described in the methods and/or operational flowcharts of the present disclosure to one or more other apparatuses. One or more transceivers 206a and 206b may receive user data, control information, radio signals/channels, etc. described in the methods and/or operational flowcharts of the present disclosure from one or more other apparatuses. For example, one or more transceivers 206a and 206b may be connected with one or more processors 202a and 202b to transmit/receive radio signals. For example, one or more processors 202a and 202b may perform control such that one or more transceivers 206a and 206b transmit user data, control information or radio signals to one or more other apparatuses. In addition, one or more processors 202a and 202b may perform control such that one or more transceivers 206a and 206b receive user data, control information or radio signals from one or more other apparatuses. In addition, one or more transceivers 206a and 206b may be connected with one or more antennas 208a and 208b, and one or more transceivers 206a and 206b may be configured to transmit/receive user data, control information, radio signals/channels, etc. described in the descriptions, functions, procedures, proposals, methods and/or operational flowcharts disclosed herein through one or more antennas 208a and 208b. In the present disclosure, one or more antennas may be a plurality of physical antennas or a plurality of logical antennas (e.g., antenna ports). One or more transceivers 206a and 206b may convert the received radio signals/channels, etc. from RF band signals to baseband signals, in order to process the received user data, control information, radio signals/channels, etc. using one or more processors 202a and 202b. One or more transceivers 206a and 206b may convert the user data, control information, radio signals/channels processed using one or more processors 202a and 202b from baseband signals into RF band signals. To this end, one or more transceivers 206a and 206b may include (analog) oscillator and/or filters.

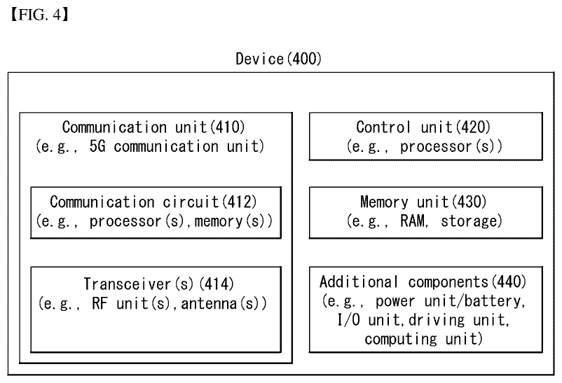

FIG. 3 illustrates a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, and a signal generator 360. At this time, for example, the operation/function of FIG. 3 may be performed by the processors 202a and 202b and/or the transceiver 206a and 206b of FIG. 2. In addition, for example, the hardware element of FIG. 3 may be implemented in the processors 202a and 202b of FIG. 2 and/or the transceivers 206a and 206b of FIG. 2. For example, blocks 1010 to 1060 may be implemented in the processors 202a and 202b of FIG. 2. In addition, blocks 310 to 350 may be implemented in the processors 202a and 202b of FIG. 2 and a block 360 may be implemented in the transceivers 206a and 206b of FIG. 2, without being limited to the above-described embodiments.

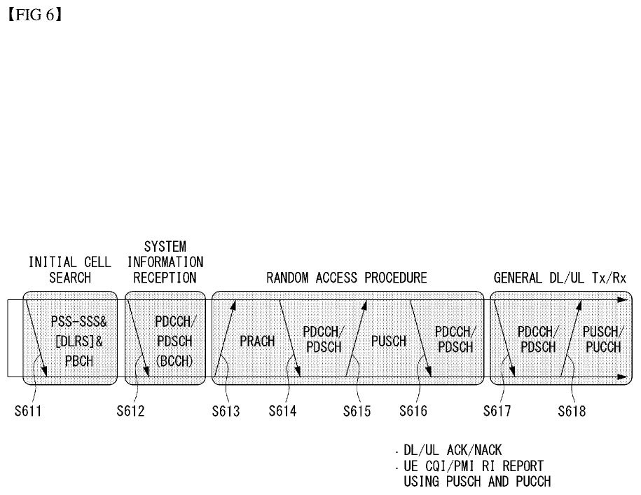

A codeword may be converted into a radio signal through the signal processing circuit 300 of FIG. 3. Here, the codeword is a coded bit sequence of an information block. The information block may include a transport block (e.g., a UL-SCH transport block or a DL-SCH transport block). The radio signal may be transmitted through various physical channels (e.g., a PUSCH and a PDSCH) of FIG. 6. Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to one or more transport layer by the layer mapper 330. Modulation symbols of each transport layer may be mapped to corresponding antenna port(s) by the precoder 340 (precoding). The output z of the precoder 340 may be obtained by multiplying the output y of the layer mapper 330 by an N*M precoding matrix W. Here, N may be the number of antenna ports and M may be the number of transport layers. Here, the precoder 340 may perform precoding after transform precoding (e.g., discrete Fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol and a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast Fourier transform (IFFT) module, a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200a or 200b of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, and a fast Fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

### Structure of Wireless Device Applicable to the Present Disclosure

FIG. 4 illustrates another example of a wireless device applicable to the present disclosure.

Referring to FIG. 4, a wireless device 400 may correspond to the wireless devices 200a and 200b of FIG. 2 and include various elements, components, units/portions and/or modules. For example, the wireless device 300 may include a communication unit 410, a control unit (controller) 420, a memory unit (memory) 430 and additional components 440. The communication unit may include a communication circuit 412 and a transceiver(s) 414. For example, the communication circuit 412 may include one or more processors 202a and 202b and/or one or more memories 204a and 204b of FIG. 2. For example, the transceiver(s) 414 may include one or more transceivers 206a and 206b and/or one or more antennas 208a and 208b of FIG. 2. The control unit 420 may be electrically connected with the communication unit 410, the memory unit 430 and the additional components 440 to control overall operation of the wireless device. For example, the control unit 420 may control electrical/mechanical operation of the wireless device based on a program/code/instruction/information stored in the memory unit 430. In addition, the control unit 420 may transmit the information stored in the memory unit 430 to the outside (e.g., another communication device) through the wireless/wired interface using the communication unit 410 over a wireless/wired interface or store information received from the outside (e.g., another communication device) through the wireless/wired interface using the communication unit 410 in the memory unit 430.

The additional components 440 may be variously configured according to the types of the wireless devices. For example, the additional components 440 may include at least one of a power unit/battery, an input/output unit, a driving unit or a computing unit. Without being limited thereto, the wireless device 300 may be implemented in the form of the robot (FIG. 1, 100a), the vehicles (FIGS. 1, 100b-1 and 100b-2), the XR device (FIG. 1, 100c), the hand-held device (FIG. 1, 100d), the home appliance (FIG. 1, 100e), the IoT device (FIG. 1, 100f), a digital broadcast terminal, a hologram apparatus, a public safety apparatus, an MTC apparatus, a medical apparatus, a Fintech device (financial device), a security device, a climate/environment device, an AI server/device (FIG. 1, 140), the base station (FIG. 1, 120), a network node, etc. The wireless device may be movable or may be used at a fixed place according to use example/service.

In FIG. 4, various elements, components, units/portions and/or modules in the wireless device 400 may be connected with each other through wired interfaces or at least some thereof may be wirelessly connected through the communication unit 410. For example, in the wireless device 400, the control unit 420 and the communication unit 410 may be connected by wire, and the control unit 420 and the first unit (e.g., 130 or 140) may be wirelessly connected through the communication unit 410. In addition, each element, component, unit/portion and/or module of the wireless device 400 may further include one or more elements. For example, the control unit 420 may be composed of a set of one or more processors. For example, the control unit 420 may be composed of a set of a communication control processor, an application processor, an electronic control unit (ECU), a graphic processing processor, a memory control processor, etc. In another example, the memory unit 430 may be composed of a random access memory (RAM), a dynamic RAM (DRAM), a read only memory (ROM), a flash memory, a volatile memory, a non-volatile memory and/or a combination thereof.

### Hand-Held Device Applicable to the Present Disclosure

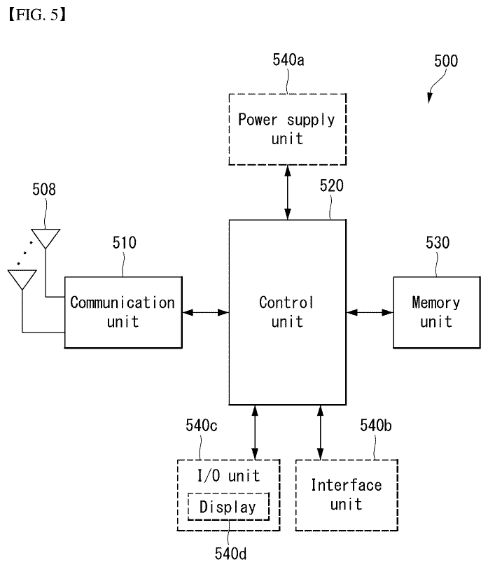

FIG. 5 illustrates an example of a hand-held device applicable to the present disclosure.

FIG. 5 shows a hand-held device applicable to the present disclosure. The hand-held device may include a smartphone, a smart pad, a wearable device (e.g., a smart watch or smart glasses), and a hand-held computer (e.g., a laptop, etc.). The hand-held device may be referred to as a mobile station (MS), a user terminal (UT), a mobile subscriber station (MSS), a subscriber station (SS), an advanced mobile station (AMS) or a wireless terminal (WT).

Referring to FIG. 5, the hand-held device 400 may include an antenna unit (antenna) 508, a communication unit (transceiver) 510, a control unit (controller) 520, a memory unit (memory) 530, a power supply unit (power supply) 540a, an interface unit (interface) 540b, and an input/output unit 540c. An antenna unit (antenna) 508 may be part of the communication unit 510. The blocks 510 to 530/540a to 540c may correspond to the blocks 410 to 430/440 of FIG. 4, respectively.

The communication unit 510 may transmit and receive signals (e.g., data, control signals, etc.) to and from other wireless devices or base stations. The control unit 520 may control the components of the hand-held device 500 to perform various operations. The control unit 520 may include an application processor (AP). The memory unit 530 may store data/parameters/program/code/instructions necessary to drive the hand-held device 400. In addition, the memory unit 530 may store input/output data/information, etc. The power supply unit 540a may supply power to the hand-held device 500 and include a wired/wireless charging circuit, a battery, etc. The interface unit 540b may support connection between the hand-held device 500 and another external device. The interface unit 540b may include various ports (e.g., an audio input/output port and a video input/output port) for connection with the external device. The input/output unit 540c may receive or output video information/signals, audio information/signals, data and/or user input information. The input/output unit 540c may include a camera, a microphone, a user input unit, a display 540d, a speaker and/or a haptic module.

For example, in case of data communication, the input/output unit 540c may acquire user input information/signal (e.g., touch, text, voice, image or video) from the user and store the user input information/signal in the memory unit 530. The communication unit 510 may convert the information/signal stored in the memory into a radio signal and transmit the converted radio signal to another wireless device directly or transmit the converted radio signal to a base station. In addition, the communication unit 510 may receive a radio signal from another wireless device or the base station and then restore the received radio signal into original information/signal. The restored information/signal may be stored in the memory unit 530 and then output through the input/output unit 540c in various forms (e.g., text, voice, image, video and haptic).

### Physical Channels and General Signal Transmission

In a radio access system, a UE receives information from a base station on a DL and transmits information to the base station on a UL. The information transmitted and received between the UE and the base station includes general data information and a variety of control information. There are many physical channels according to the types/usages of information transmitted and received between the base station and the UE.

FIG. 6 illustrates physical channels applicable to the present disclosure and a signal transmission method using the same.

The UE which is turned on again in a state of being turned off or has newly entered a cell performs initial cell search operation in step S611 such as acquisition of synchronization with a base station. Specifically, the UE performs synchronization with the base station, by receiving a Primary Synchronization Channel (P-SCH) and a Secondary Synchronization Channel (S-SCH) from the base station, and acquires information such as a cell Identifier (ID).

Thereafter, the UE may receive a physical broadcast channel (PBCH) signal from the base station and acquire intra-cell broadcast information. Meanwhile, the UE may receive a downlink reference signal (DL RS) in an initial cell search step and check a downlink channel state. The UE which has completed initial cell search may receive a physical downlink control channel (PDCCH) and a physical downlink control channel (PDSCH) according to physical downlink control channel information in step S612, thereby acquiring more detailed system information.

Thereafter, the UE may perform a random access procedure such as steps S613 to S616 in order to complete access to the base station. To this end, the UE may transmit a preamble through a physical random access channel (PRACH) (S613) and receive a random access response (RAR) to the preamble through a physical downlink control channel and a physical downlink shared channel corresponding thereto (S614). The UE may transmit a physical uplink shared channel (PUSCH) using scheduling information in the RAR (S615) and perform a contention resolution procedure such as reception of a physical downlink control channel signal and a physical downlink shared channel signal corresponding thereto (S616).

The UE, which has performed the above-described procedures, may perform reception of a physical downlink control channel signal and/or a physical downlink shared channel signal (S617) and transmission of a physical uplink shared channel (PUSCH) signal and/or a physical uplink control channel (PUCCH) signal (S618) as general uplink/downlink signal transmission procedures.

The control information transmitted from the UE to the base station is collectively referred to as uplink control information (UCI). The UCI includes hybrid automatic repeat and request acknowledgement/negative-ACK (HARQ-ACK/NACK), scheduling request (SR), channel quality indication (CQI), precoding matrix indication (PMI), rank indication (RI), beam indication (BI) information, etc. At this time, the UCI is generally periodically transmitted through a PUCCH, but may be transmitted through a PUSCH in some embodiments (e.g., when control information and traffic data are simultaneously transmitted). In addition, the UE may aperiodically transmit UCI through a PUSCH according to a request/instruction of a network.

FIG. 7 illustrates the structure of a radio frame applicable to the present disclosure.

UL and DL transmission based on an NR system may be based on the frame shown in FIG. 7. At this time, one radio frame has a length of 10 ms and may be defined as two 5-ms half-frames (HFs). One half-frame may be defined as five 1-ms subframes (SFs). One subframe may be divided into one or more slots and the number of slots in the subframe may depend on subscriber spacing (SCS). At this time, each slot may include 12 or 14 OFDM (A) symbols according to cyclic prefix (CP). If normal CP is used, each slot may include 14 symbols. If an extended CP is used, each slot may include 12 symbols. Here, the symbol may include an OFDM symbol (or a CP-OFDM symbol) and an SC-FDMA symbol (or a DFT-s-OFDM symbol).

Table 1 shows the number of symbols per slot according to SCS, the number of slots per frame and the number of slots per subframe when normal CP is used, and Table 2 shows the number of symbols per slot according to SCS, the number of slots per frame and the number of slots per subframe when extended CP is used.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

TABLE 2

| μ | ${N}_{symb}^{slot}$ | ${N}_{slot}^{frame , μ}$ | ${N}_{slot}^{subframe , μ}$ |
|---|---|---|---|
| 2 | 12 | 40 | 4 |

In Tables 1 and 2 above,

$${N}_{symb}^{slot}$$

may indicate the number of symbols in a slot,

$${N}_{slot}^{frame , μ}$$

may indicate the number of slots in a frame, and

$${N}_{slot}^{subframe , μ}$$

may indicate the number of slots in a subframe.

In addition, in a system, to which the present disclosure is applicable, OFDM (A) numerology (e.g., SCS, CP length, etc.) may be differently set among a plurality of cells merged to one UE. Accordingly, an (absolute time) period of a time resource (e.g., an SF, a slot or a TTI) (for convenience, collectively referred to as a time unit (TU)) composed of the same number of symbols may be differently set between merged cells.

NR may support a plurality of numerologies (or subscriber spacings (SCSs)) supporting various 5G services. For example, a wide area in traditional cellular bands is supported when the SCS is 15 kHz, dense-urban, lower latency and wider carrier bandwidth are supported when the SCS is 30 kHz/60 kHz, and bandwidth greater than 24.25 GHz may be supported to overcome phase noise when the SCS is 60 kHz or higher.

An NR frequency band is defined as two types (FR1 and FR2) of frequency ranges. FR1 and FR2 may be configured as shown in the following table. In addition, FR2 may mean millimeter wave (mmW).

TABLE 3

| Frequency Range | Corresponding | | |
|---|---|---|---|
| designation | frequency range | Subcarrier Spacing | |
| FR1 | 410 MHz-7125 MHz | 15,30, 60 | kHz |
| FR2 | 24250 MHz-52600 MHz | 60, 120, 240 | kHz |

In addition, for example, in a communication system, to which the present disclosure is applicable, the above-described numerology may be differently set. For example, a terahertz wave (THz) band may be used as a frequency band higher than FR2. In the THz band, the SCS may be set greater than that of the NR system, and the number of slots may be differently set, without being limited to the above-described embodiments.

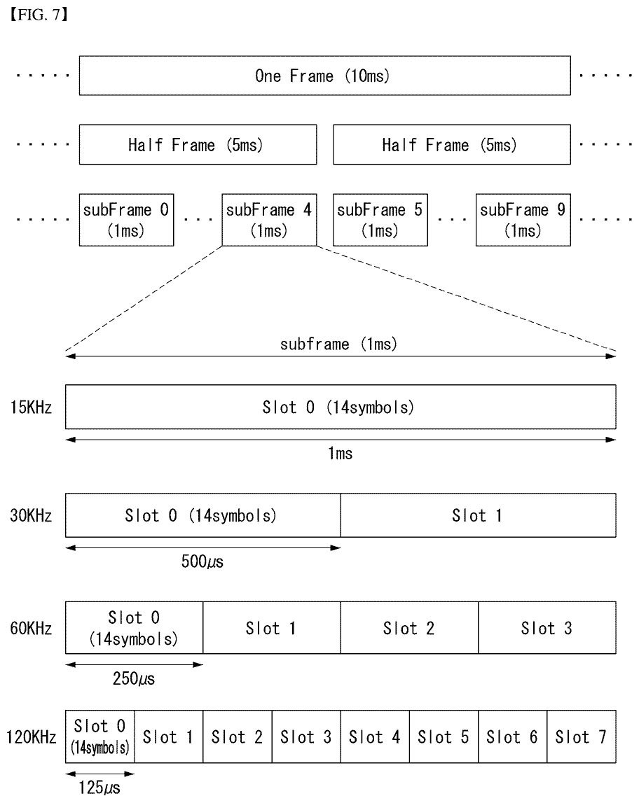

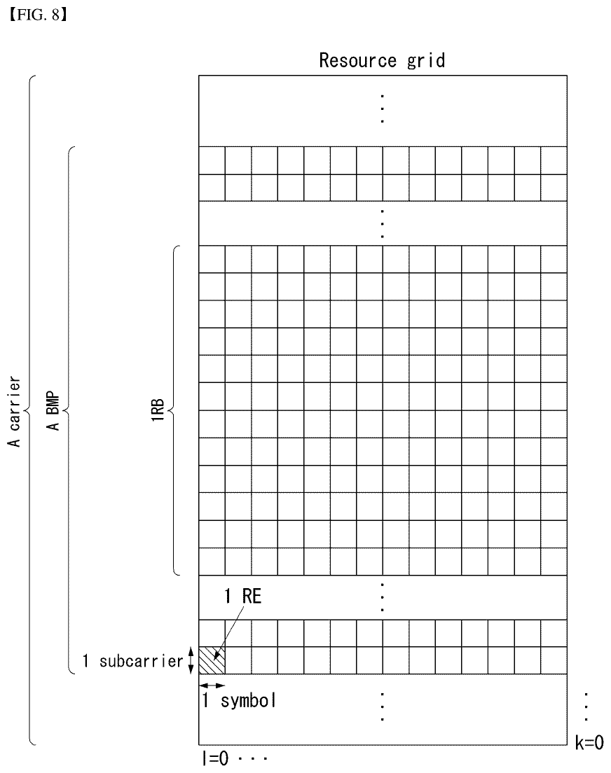

FIG. 8 illustrates a slot structure applicable to the present disclosure.

One slot includes a plurality of symbols in the time domain. For example, one slot includes seven symbols in case of normal CP and one slot includes six symbols in case of extended CP. A carrier includes a plurality of subcarriers in the frequency domain. A resource block (RB) may be defined as a plurality (e.g., 12) of consecutive subcarriers in the frequency domain.

In addition, a bandwidth part (BWP) is defined as a plurality of consecutive (P) RBs in the frequency domain and may correspond to one numerology (e.g., SCS, CP length, etc.).

The carrier may include a maximum of N (e.g., five) BWPs. Data communication is performed through an activated BWP and only one BWP may be activated for one UE. In resource grid, each element is referred to as a resource element (RE) and one complex symbol may be mapped

### 6G Communication System

A 6G (wireless communication) system has purposes such as (i) very high data rate per device, (ii) a very large number of connected devices, (iii) global connectivity, (iv) very low latency, (v) decrease in energy consumption of battery-free IoT devices, (vi) ultra-reliable connectivity, and (vii) connected intelligence with machine learning capacity. The vision of the 6G system may include four aspects such as “intelligent connectivity”, “deep connectivity”, “holographic connectivity” and “ubiquitous connectivity”, and the 6G system may satisfy the requirements shown in Table 4 below. That is, Table 4 shows the requirements of the 6G system.

TABLE 4

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | Up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

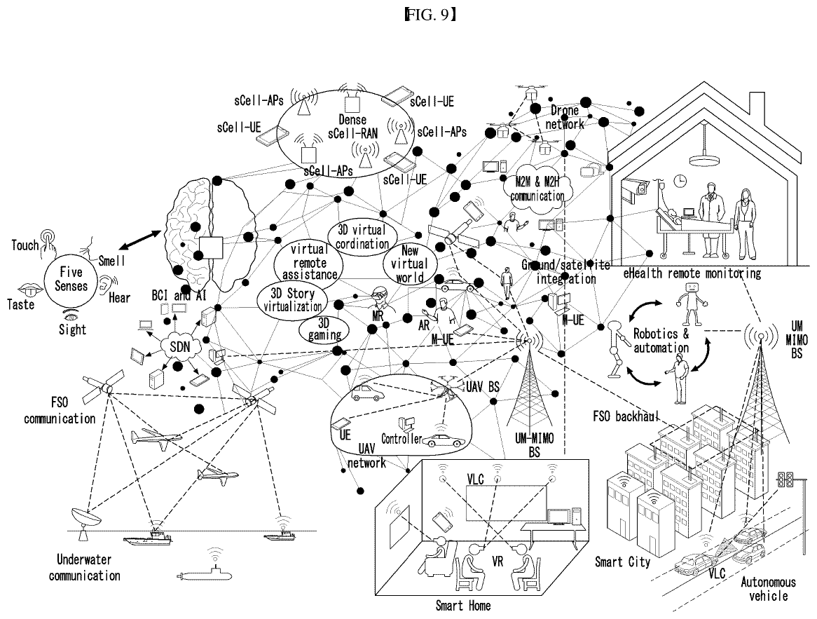

FIG. 9 illustrates an example of a communication structure providable in a 6G system applicable to the present disclosure.

Referring to FIG. 9, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system. In addition, in 6G, new network characteristics may be as follows.
Satellites integrated network: To provide a global mobile group, 6G will be integrated with satellite. Integrating terrestrial waves, satellites and public networks as one wireless communication system may be very important for 6G.
Connected intelligence: Unlike the wireless communication systems of previous generations, 6G is innovative and wireless evolution may be updated from “connected things” to “connected intelligence”. AI may be applied in each step (or each signal processing procedure which will be described below) of a communication procedure.
Seamless integration of wireless information and energy transfer: A 6G wireless network may transfer power in order to charge the batteries of devices such as smartphones and sensors. Therefore, wireless information and energy transfer (WIET) will be integrated.
Ubiquitous super 3-dimemtion connectivity: Access to networks and core network functions of drones and very low earth orbit satellites will establish super 3D connection in 6G ubiquitous.

In the new network characteristics of 6G, several general requirements may be as follows.
Small cell networks: The idea of a small cell network was introduced in order to improve received signal quality as a result of throughput, energy efficiency and spectrum efficiency improvement in a cellular system. As a result, the small cell network is an essential feature for 5G and beyond 5G (5 GB) communication systems. Accordingly, the 6G communication system also employs the characteristics of the small cell network.
Ultra-dense heterogeneous network: Ultra-dense heterogeneous networks will be another important characteristic of the 6G communication system. A multi-tier network composed of heterogeneous networks improves overall QoS and reduces costs.
High-capacity backhaul: Backhaul connection is characterized by a high-capacity backhaul network in order to support high-capacity traffic. A high-speed optical fiber and free space optical (FSO) system may be a possible solution for this problem.
Radar technology integrated with mobile technology: High-precision localization (or location-based service) through communication is one of the functions of the 6G wireless communication system. Accordingly, the radar system will be integrated with the 6G network.
Softwarization and virtualization: Softwarization and virtualization are two important functions which are the bases of a design process in a 5 GB network in order to ensure flexibility, reconfigurability and programmability.

### Quantum Communication

Quantum communication is a next-generation communication technology that can overcome the limitations of existing information and communication, such as security and ultra-fast computation, by applying quantum mechanical properties to the information and communication field. The quantum communication provides a means to generate, transmit, process, and store information in the form that cannot be expressed or is difficult to express in the form of 0 and 1 according to binary bit information used in existing communication technologies. In the existing communication technologies, wavelengths, amplitudes, or the like have been used for information transmission between a transmitting terminal and a receiving terminal, but in the quantum communication, a photon, which is the smallest unit of light, is used for the information transmission between the transmitting terminal and the receiving terminal. In particular, the quantum communication can utilize quantum uncertainty and quantum irreversibility for the polarization or phase difference of photons (light), and thus the quantum communication has the characteristic of enabling communication with perfect security. The quantum communication can also enable ultra-fast communication using quantum entanglement under certain conditions.

### DEFINITION OF TERMS

For convenience of description, the following symbols/abbreviations/terms may be used in the present disclosure.
QDC: Quantum Direct Communication
QSDC: Quantum Secure Direct Communication
QBER: Quantum Bit Error Rate
QKD: Quantum Key Distribution
LD: Laser Diode
SPD: Single Photon Detector
Pol_mod: Polarization Modulator
OSW: Optical Switch
WP: Wave Plate
PBS: Polarization beam splitter
BSM: Bell State Measurement
EPR-pair: Einstein-Podolsky-Rosen pair
QRNG: Quantum random number generator
AES: Advanced Encryption Standard
PQC: Post Quantum Cryptography
VCWP: Voltage controlled wave plate

Among quantum communication techniques, a quantum direct communication technique is a technique for securely transmitting classical message information in the same manner as quantum key distribution (QKD) used in a 4G/5G secure communication technology. However, the QKD refers to a technique in which symmetric secret key information required for securely transmitting message information transmitted on a classical channel is securely shared on a quantum channel by using quantum mechanical properties of no-cloning, whereas QDC refers to a technique to securely share classical message information to be transmitted directly on a quantum channel, rather than a secret key. A main QDC technology group is quantum secure direct communication (QSDC), which has the advantage of ensuring high security by not generating leakage information related to transmission information. The QSDC can be classified into a DL04 technique using a single-photon light source and a two-step QSDC technique using an entangled light source. The two techniques use a quantum memory using a long delay line based on optical fiber. In order to ensure the security, a round-trip structure is used in the DL04 technique, and a structure in which information is dividedly transmitted in two steps is used in the two-step QSDC technique. As a result, there is a problem that a distance loss of classical message information transmitted via photons is very large compared to a length of a channel between actual transceivers. In general, considering that a loss according to a transmission distance in 1550 nm wired optical fiber, which is mainly used in the quantum communication, or the atmosphere on a clear day is 0.2 dB/km, it is important to minimize the information loss problem by minimizing an actual transmission distance of photons in a quantum direct communication system.

To solve the above problem, the present disclosure proposes a method for minimizing an information loss by minimizing an actual transmission distance of photons. First, a single-photon-based DL04 QSDC technique and an entanglement-based two-step QSDC technique are exemplified to describe a cause of a problem of loss of message information due to use of a transmission distance greater than or equal to a channel length.

### DL04 QSDC Protocol

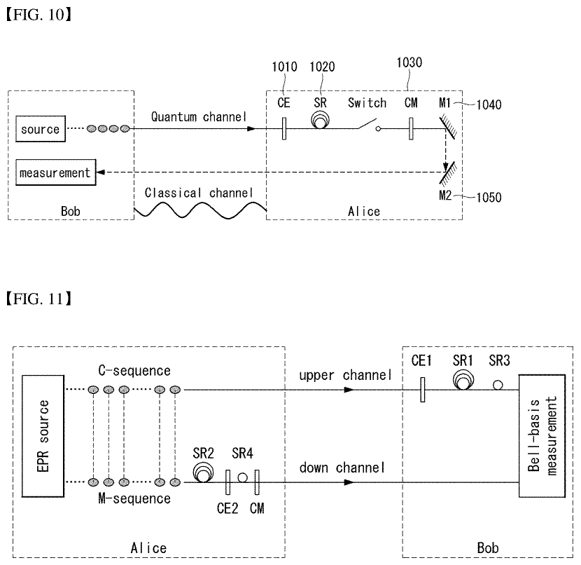

FIG. 10 illustrates overall configuration of DL04 QSDC protocol. In FIG. 10, ‘1010’ is checking eavesdropping (CE) and is a part of checking whether there is an eavesdropper, ‘1020’ is a storage line (SR) and is an optical delay line serving as a quantum memory, ‘1030’ is a coding message (CM) and is a part for coding message information to be transmitted, and ‘1040’ and ‘1050’ denote a mirror.

Referring to FIG. 10, Bob, a receiving terminal, transmits an initial quantum state to Alice, a transmitting terminal, using a single photon and performs quantum bit error rate (QBER) estimation using some of information on the initial quantum state. In this instance, Bob, the receiving terminal, sends, to Alice, the transmitting terminal, information on a location to be used for the QBER estimation among the initial quantum states by using a classical channel. Then, Alice, the transmitting terminal, transmits measurement information measured based on the information on the location to Bob, the receiving terminal, and Bob, the receiving terminal, compares the received measurement information with quantum state information, that he initially has generated, to calculate a QBER. Next, Bob, the receiving terminal, checks whether there was an eavesdropper on a quantum channel while transmitting the initial quantum information by checking whether the calculated QBER value is greater than a threshold which is a reference value for determining whether there is eavesdropping. In this instance, while the QBER estimation is performed, remaining photon information that is not used for the QBER estimation is stored in the quantum memory SR (1020). Because the QBER estimation requires enough time to transmit and receive information on a classical channel with the same length as the quantum channel, a length of the SR must satisfy more than twice a minimum quantum channel length. When it is checked through the QBER estimation that there is no eavesdropper on the quantum channel, the CM (1030) codes classical message information, that the transmitting terminal wants to transmit, into the transmitted initial quantum state, and then the coded classical message information is transmitted to the receiving terminal on the quantum channel. In this instance, the eavesdropper may attempt to eavesdrop on information transmitted on the quantum channel, but the eavesdropper did not obtain the information initially transmitted on the quantum channel. Therefore, even if the eavesdropper intercepts information transmitted on the quantum channel, the eavesdropper can only obtain meaningless random number sequences of information, and it is impossible to restore meaningful message information from the intercepted information. Through this process, the security of transmission information can be ensured when using a quantum communication method.

When a distance loss of the transmission information when passing through a length of a one-way quantum channel is called l_{d}, a distance loss compared to an actual transmission distance that can be determined through the overall information transmission process in the DL04 protocol described above is as follows.

Total distance loss of the DL04 technique=\textcircled{1}+\textcircled{2}≥4_{ld}
\textcircled{1} Since the quantum channel is a round-trip structure and is passed through twice, a distance loss equal to twice the quantum channel length occurs=2_{ld}
\textcircled{2} Since related information must be transmitted and received on a classical channel during the QBER estimation, a distance loss equal to twice the quantum channel length occurs=2_{ld}

As above, the DL04 protocol has a problem in that a distance loss of up to four times the actual channel length occurs due to a distance loss caused by the initial quantum state information transmission and quantum information transmission process and a distance loss for transmitting and receiving related information for the QBER estimation.

### Two-Step QSDC Protocol

An actual transmission distance loss in a two-step QSDC protocol is described below. FIG. 11 illustrates an example of an information transmission method in a two-step QSDC protocol. The two-step QSDC is a technique derived from super dense coding, and is a technique for securely transmitting 2 bits of classical information using four types of single entangled photons (EPR-pairs) of Equation 1 below.

$${{{{\vert {Ψ}^{-} 〉 = \frac{1}{\sqrt{2}} ( \vert 0 〉}_{C} \vert 1 〉}_{M} - \vert 1 〉}_{C} \vert 0 〉}_{M} ) \to 00 \qquad [ Equation 1 ]$$

$${{{{\vert {Ψ}^{+} 〉 = \frac{1}{\sqrt{2}} ( \vert 0 〉}_{C} \vert 1 〉}_{M} + \vert 1 〉}_{C} \vert 0 〉}_{M} ) \to 01$$

$${{{{\vert {ϕ}^{-} 〉 = \frac{1}{\sqrt{2}} ( \vert 0 〉}_{C} \vert 0 〉}_{M} - \vert 1 〉}_{C} \vert 1 〉}_{M} ) \to 10$$

$${{{{\vert {ϕ}^{+} 〉 = \frac{1}{\sqrt{2}} ( \vert 0 〉}_{C} \vert 0 〉}_{M} + \vert 1 〉}_{C} \vert 1 〉}_{M} ) \to 11$$

The super dense coding is a technique that enables classical information to be transmitted using quantum communication. When the super dense coding is used, a transmitting terminal may transmit 2 bits of classical information to a remote receiving terminal through a quantum channel using one qubit. When the super dense coding is used, it is assumed that the transmitting terminal possesses a first qubit of an entangled state, and the receiving terminal possesses a second qubit of the entangled state. There are four cases in which a qubit that the transmitting terminal wants to transmit is ‘00’, ‘01’, ‘10’ and ‘11’. For the four cases, the transmitting terminal performs a qubit operation (expressed in the form of I, Z, X, iY) corresponding to each of the four cases on the entangled qubit possessed by the transmitting terminal, and then transmits it on the quantum channel. Each operation performed by the transmitting terminal can be understood as transforming the entangled state shared by the transmitting terminal and the receiving terminal into different basises that are orthogonal to each other. The receiving terminal measures the received qubit and its own qubit (the second qubit in the entangled state) to restore 2 bits of information transmitted by the transmitting terminal.

In FIG. 11, storage line (SR)1, SR2, SR3 and SR4 are optical delay lines serving as a quantum memory, checking eavesdropping (CE)1 and CE2 check whether there is an eavesdropper, a coding message (CM) encodes classical message information that a transmitting terminal (Alice) wants to transmit to a receiving terminal (Bob), EPR-source generates an entangled light source, and Bell-state measurement measures an entangled photon pair.

Unlike the super dense coding, in the two-step QSDC, in order to ensure the security, the entangled photon pair is not transmitted all at once, but is transmitted in two steps through an upper quantum channel and a down quantum channel. In order to eavesdrop on an entangled light source, information from both sides of the entangled photon pair must be known to find out transmission information through measurement. Therefore, in the two-step technique, one side of the entangled photon pair is first sent to verify its security from eavesdropping, and only when the security is guaranteed, message information to be sent is encoded on the remaining side of the entangled photon pair and transmitted.

When a distance loss of the transmission information when passing through a length of a one-way quantum channel is called l_{d}, a distance loss compared to an actual transmission distance that can be determined through the overall information transmission process in the two-step QSDC protocol described above is as follows.

A distance loss compared to an actual transmission distance that can be determined through the process of the two-step QSDC protocol described above is as follows.

Total distance loss of the two-step technique=\textcircled{1}+\textcircled{2}+\textcircled{3}≥4_{ld}
\textcircled{1} Distance loss caused by passing through the quantum channel=l_{d}
\textcircled{2} Since related information must be transmitted and received on a classical channel during the QBER estimation, a distance loss equal to twice the quantum channel length occurs=2_{ld}
\textcircled{3} Distance loss that occurs during the time it takes for the remaining quantum photon pairs to be message-coded and transmitted=l_{d}

As described above, it can be seen that both the transmission method in the DL04 protocol and the transmission method in the two-step QSDC protocol cause a very large distance loss of transmission information compared to the actual transmission distance, as photons pass through a distance that is at least four times the channel distance.

To solve the above problem, the present disclosure proposes an efficient one-way and one-step QDC technique that can solve the problem of existing techniques having to store a photon without measuring it for a time corresponding to four times a channel length.

In the existing QDC protocol, even after initial information is transmitted on a quantum channel, photon state information must be continuously stored for a period of time equal to three times a length of the quantum channel corresponding to a process of receiving message information from an eavesdropper in order to perform a QBER estimation process which is a security verification process. More specifically, in the existing entanglement-based two-step QSDC protocol, a checking sequence for QBER estimation among an EPR pair is first transmitted, then security verification is performed, and if the security is guaranteed as a result, a message coding sequence is transmitted subsequently. Subsequently, two sequences (checking sequence and message coding sequence) are used for measurement, and a transmitting terminal transmits the classical message information to a receiving terminal. Since information transmission and reception are performed through the above process, the receiving terminal must store the checking sequence in a quantum memory until an additional message sequence is received after receiving the checking sequence. When a storage time required in the quantum memory in the two-step QSDC technique is defined as t, the time can be expressed as in Equation 2 below.

$$τ \geq \frac{3 L}{C} + \frac{N}{f} \qquad [ Equation 2 ]$$

(τ: storage time of the quantum memory, L: channel length,
C: speed of photon, N: the number of EPR pairs included in a single block,
f: the number of photons transmitted per unit time)

That is, when the channel length is L, it can be seen that a time equal to three times the minimum channel length is required because after the checking sequence is transmitted, additional information (for QBER estimation) must be transmitted from the transmitting terminal to the receiving terminal via the classical channel, and then the message coding sequence must be transmitted from the transmitting terminal to the receiving terminal.

Considering that quantum memory is mainly configured using optical cables, considering the 1550 nm wavelength that is mainly used as a communication wavelength, a loss per distance of the optical cables is 0.2 dB/km. Therefore, as a transmission distance increases, a loss of the transmitted photon information increases proportionally. Accordingly, a method is required to minimize a portion where the distance loss of the photon is greater than a loss corresponding to the length of the quantum channel. In order to implement the above method, a one-way or one-step QDC method that does not require the quantum memory may be considered to minimize the distance loss of the single-photon based QDC technique. In this instance, the following requirements must be satisfied to implement the one-way or one-step QDC method.

(1) In order to use a QDC technique with one-way and one-step structure, it is necessary to be able to block the possibility of an information loss due to a random basis selection in a single-photon information measurement process. More specifically, in the DL04 protocol which is a single-photon based classical information transmission technique, through a system with a round-trip structure, (i) an initial quantum state initially generated by a receiving terminal and (ii) a message-coded quantum state returned to the receiving terminal after message coding by a transmitting terminal are configured to be measurable in the same basis as a basis used when generating the initial quantum state by the receiving terminal. Therefore, there is no loss of measurement information due to basis mismatch during the measurement process. However, as described above, since a large distance loss occurs in the round-trip structure, application of the one-way QDC technique capable of minimizing this is required. But, if a single photon is transmitted in one-way, the receiving terminal cannot know a state of information transmitted from the transmitting terminal. Therefore, when the measurement is performed in an arbitrary basis, there is a problem that the measurement is performed based on an incorrect basis with a 50% probability, which may result in a loss of a large amount of transmission information.

(2) In order to use the QDC technique with one-way and one-step structure, even if information leaks on a quantum channel before estimating whether there is an eavesdropper, it should be able to prevent the eavesdropper from obtaining meaningful information. More specifically, the presence of the eavesdropper on the quantum channel can be determined by QBER estimation using a portion of information transmitted on a one-way quantum channel, but there is a possibility that the eavesdropper may intercept information transmitted on the quantum channel before the QBER estimation is completed between the transmitting terminal and the receiving terminal when transmitting information on the one-way quantum channel. In the QDC technique of the round-trip structure (DL04 protocol) or two-step QSDC, information initially transmitted does not contain message information and is used only for the purpose of checking the presence of the eavesdropper, and the message information is transmitted only after the security of the quantum channel is verified. However, in the QDC technique through one-way and one-step, (i) information initially transmitted on the quantum channel includes both information for QBER estimation and message information, (ii) the receiving terminal performs the QBER estimation using some of the information for QBER estimation among the initially transmitted information, and (iii) since the presence of the eavesdropper is checked through this, the eavesdropper can eavesdrop on the initially transmitted information including both the information for QBER estimation and the message information when performing the QDC technique through one-way and one-step, so eavesdropping on the message information cannot be blocked in advance. Accordingly, even if the message information included in the initially transmitted information when performing the QDC technique through one-way and one-step is eavesdropped and leaked, a method is required to prevent the eavesdropper from obtaining meaningful information.

The present disclosure proposes a method and a device for minimizing a transmission distance loss equal to four times or more of a channel length caused by structural characteristics for ensuring the security of the existing QDC technique, while satisfying the requirements of (1) and (2) above. Unlike the existing QDC technique where information not including a transmission message, that is a secret key, is first transmitted and then message information is exchanged between the transmitting terminal and the receiving terminal, in a QDC method through one-way and one-step proposed in the present disclosure, message information is first encrypted or scrambled and transmitted, and then information that is a secret key used to restore a message at a receiving terminal is transmitted.

More specifically, the present disclosure proposes a method in which a transmitting terminal transmits a single photon pair to a receiving terminal in one-way at a time, and then the receiving terminal measures information transmitted based on two different random basises, and a loss in a measurement process cannot occur even in a one-way transmission technique through the above method. The present disclosure also proposes a method of scrambling or encrypting a message transmitted from a transmitting terminal and transmitting it on a quantum channel. Through the above method, even if information transmitted from the transmitting terminal is eavesdropped, an eavesdropper cannot obtain meaningful information, and a structural security problem of being able to determine the presence of the eavesdropper only after information transmitted from the transmitting terminal has been eavesdropped can be resolved. The present disclosure also proposes a method of transmitting key information, that is used by a transmitting terminal to restore scrambled or encrypted received information at a receiving terminal, on a classical channel only when security is guaranteed through QBER estimation after message transmission at the transmitting terminal, and the security of transmission information can be ensured through the above method.

### Single-Photon Pair Based One Way & One Step QDC Protocol

The methods proposed in the present disclosure mentioned above are described in detail below. First, an overall process in which the methods proposed in the present disclosure are performed is described.

FIG. 12 is a flowchart illustrating an example of an overall performance process of a method described in the present disclosure.

S12010: A transmitting terminal 1210 generates a single photon pair with a constant polarization state. The single photon pair generated in the step S12010 may be used for polarization coding of message information transmitted from the transmitting terminal 1210 to a receiving terminal 1220, in step S12030. The information transmitted from the transmitting terminal 1210 to the receiving terminal 1220 may be classical message information.

S12020: Subsequently, the transmitting terminal 1210 generates transmission information (classical information) of a hybrid binary/sequence by randomly mixing (i) the message information to be transmitted to the receiving terminal 1220 and (ii) a checking sequence used for quantum bit error rate (QBER) estimation to check whether an eavesdropper has eavesdropped. Since the transmitting terminal 1210 generates a sequence in which the message information and the checking sequence used for QBER estimation are randomly mixed, the eavesdropper or the receiving terminal 1220 does not know location information within the generated sequence of the checking sequence. Therefore, the eavesdropper or the receiving terminal 1220 cannot determine a location of a signal used for QBER estimation without sharing the location information within the generated sequence. An operation for the transmitting terminal 1210 to generate the transmission information of the hybrid binary/sequence may be understood as the transmitting terminal 1210 generating a transmission information sequence including (i) a message sequence related to the information and (ii) a checking sequence related to QBER estimation for determining whether there is eavesdropping on a quantum channel, wherein the checking sequence is randomly inserted between sequence elements of the message sequence. Subsequently, in order to prevent the eavesdropper from obtaining meaningful information even if a transmission message information is exposed to the eavesdropper, the transmitting terminal 1210 performs scrambling or encryption on classical information to be transmitted to the receiving terminal 1220. A process in which the hybrid sequence is generated by randomly mixing the message information and the checking sequence used for QBER estimation is described in more detail with reference to FIG. 13.

FIG. 13 illustrates an example of a process in which a hybrid sequence is generated through a process for signal generation performed in a signal generation unit of a transmitting terminal, and scrambling/encryption is applied to the generated hybrid sequence.

Referring to FIG. 13, the transmitting terminal 1210 generates a message sequence (message information) 1301 and a checking sequence 1302 for QBER estimation, in S1310. Subsequently, the transmitting terminal 1210 randomly inserts the checking sequence for QBER estimation into the message sequence to generate a hybrid sequence including both the message sequence and the checking sequence, in S1320. The hybrid sequence may be referred to as a transmission information sequence. Subsequently, the transmitting terminal 1210 performs scrambling or encryption on the generated hybrid sequence, in S1330. As a result of the step S1330, a classical sending sequence is generated.

S12030: Referring again to FIG. 12, the transmitting terminal 1210 performs a polarization coding on the hybrid sequence, on which one of the scrambling or the encryption is performed, and transmits polarization coded information to the receiving terminal 1220 on the quantum channel. The polarization coding is performed using the single-photon pair generated in the step S12010. Here, the polarization-coded hybrid sequence may also be understood/called quantum information in that it is information transmitted on the quantum channel. In the message information among information included in the hybrid sequence, the same polarization coding is performed on two photons constituting the photon pair. Here, when the polarization coding is performed on the message information, four patterns for the polarization coding may be generated.

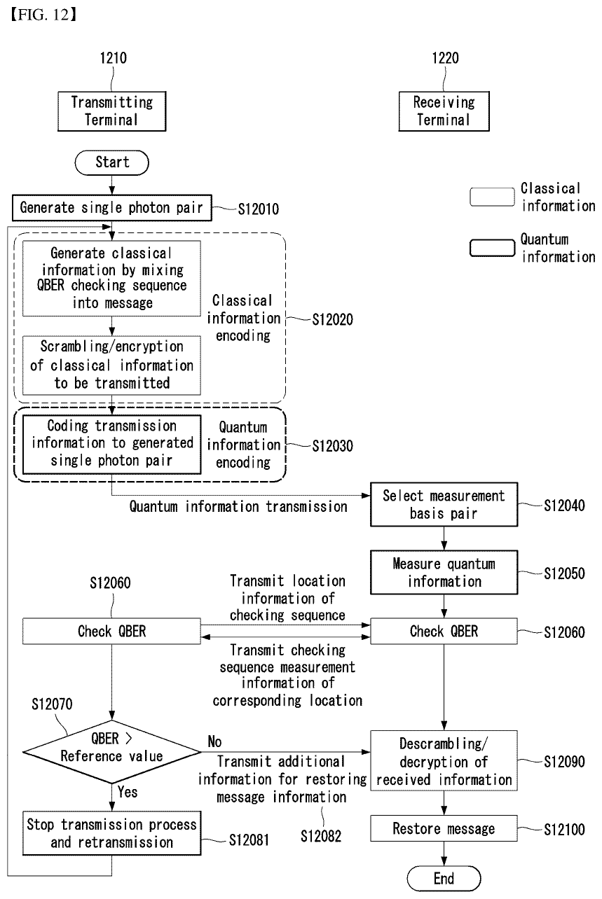

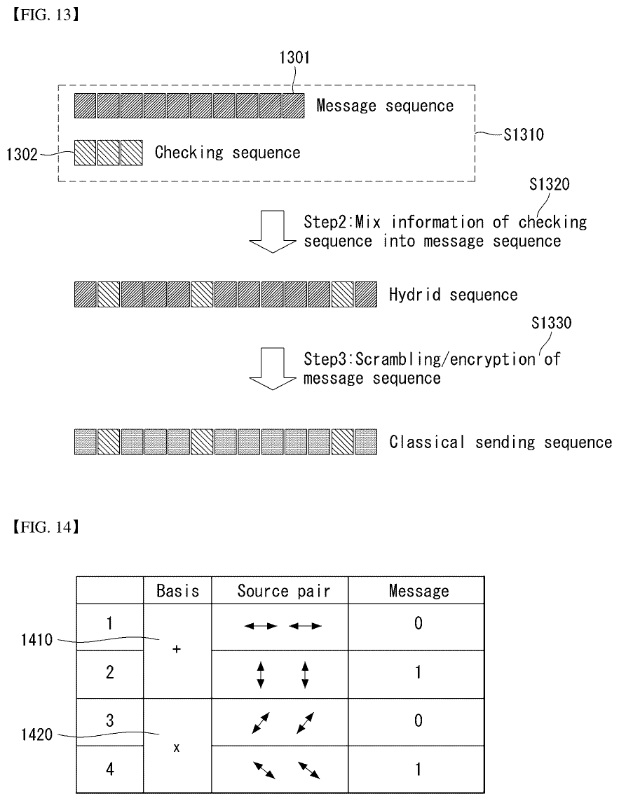

FIG. 14 illustrates a polarization coding rule of a single photon pair based on classical message information. Referring to FIG. 14, two types of basises [+(1410) and ×(1420)] are defined for polarization coding of message information, and two photon pairs subjected to the same polarization coding are defined for each basis. For the basis +(1410), a photon pair subjected to 0-degree polarization coding and a photon pair subjected to 90-degree polarization coding are defined, the photon pair subjected to the 0-degree polarization coding corresponds to message information 0, and the photon pair subjected to the 90-degree polarization coding corresponds to message information 1. For the basis ×(1420), a photon pair subjected to 45-degree polarization coding and a photon pair subjected to 135-degree polarization coding are defined, the photon pair subjected to the 45-degree polarization coding corresponds to message information 0, and the photon pair subjected to the 135-degree polarization coding corresponds to message information 1. In the information used for QBER estimation among the information included in the hybrid sequence, the same or different polarization coding is performed on two photons constituting the photon pair. Here, when the polarization coding is performed on the information used for QBER estimation, 16 patterns for the polarization coding may be generated. The 16 patterns defined for polarization coding of the information used for QBER estimation will be described together in the description related to a QBER estimation operation below.

S12040 and S12050: Next, the receiving terminal 1220 selects a pair of two different measurement basises to measure the single photon pair transmitted from the transmitting terminal 1210.

S12060: The transmitting terminal 1210 transmits information on the basis used for polarization coding to the receiving terminal 1220. Subsequently, the receiving terminal 1220 uses a result measured through the same basis as the basis used for polarization coding, as a reception result, based on the information on the basis.

Further, the transmitting terminal 1210 transmits location information of the checking sequence transmitted for QBER estimation to the receiving terminal 1220 on a classical channel, and the receiving terminal 1220 transmits a measurement result of a location corresponding to the location information to the transmitting terminal 1210. In the above example where information ‘001101’ which has been scrambled or encrypted is transmitted from the transmitting terminal 1210 to the receiving terminal 1220, if 5th and 6th locations are information for QBER estimation, the receiving terminal 1220 transmits measurement values at the 5th and 6th locations to the transmitting terminal 1210.

S12070: The transmitting terminal 1210 compares the information generated by the transmitting terminal 1210 with the measurement result transmitted by the receiving terminal 1220 to perform QBER estimation and determines whether or not the quantum information has been eavesdropped based on a result of the QBER estimation. The QBER estimation may be performed by comparing a predefined reference value for determining whether there is eavesdropping and a QBER estimation value. In this instance, if the QBER estimation value is greater than the reference value for determining whether there is eavesdropping, it is determined that eavesdropping has occurred on the quantum channel, and at this time, the transmitting terminal 1210 stops the transmission process and prepares for a retransmission process. When the retransmission process is performed, the step S12020 and subsequent operations may be performed. If the QBER estimation value is less than the reference value for determining whether there is eavesdropping, it is determined that there is no eavesdropping on the quantum channel, and at this time, the transmitting terminal 1210 performs the subsequent process. If the QBER estimation value has a value greater than or equal to the reference value for determining whether there is eavesdropping, the transmitting terminal 1210 and the receiving terminal 1220 determine that eavesdropping has occurred.

S12082: If the transmitting terminal 1210 determines that no eavesdropping has occurred on the quantum channel in the step S12070, the transmitting terminal 1210 transmits, on the classical channel, additional information for restoring the message information from the encrypted or scrambled information measured at the receiving terminal 1220.

S12090 and S12100: Subsequently, the receiving terminal 1220 descrambles the scrambled information or decrypts the encrypted information based on the additional information, and restores the message information from the descrambled or decrypted information.

With reference to FIG. 12, the schematic procedures in which the method proposed in the present disclosure is performed are described above, and a more specific message transmission and measurement process, and a QBER estimation process are described below.

The system for one-way and one-step QDC transmission proposed in the present disclosure may be configured based on a parallel structure that transmits information by simultaneously transmitting a photon pair, or a serial structure that transmits information using two photons (photon pair) generated sequentially. Since the overall process is the same in the two structures, a more specific message transmission and measurement process and a QBER estimation process will be described focusing on a system for one-way and one-step QDC transmission based on the parallel structure, for convenience of description. In addition, a system for one-way and one-step QDC transmission based on the serial structure, for convenience of description will be described focusing on a difference from the system for one-way and one-step QDC transmission based on the parallel structure.

### Parallel Structure

The parallel structure can process the same amount of message information faster than the serial structure because it simultaneously generates and transmits two single-photon sources compared to the serial structure that must use single-photon source pairs that are generated sequentially. However, the parallel structure may have a higher configuration complexity than the serial structure because it requires a process of individually generating and measuring two photons. A method proposed in the present disclosure based on the parallel structure may be summarized as (1) a process in which after a transmitting terminal generates a single photon and then scrambles or encrypts classical information to be transmitted, the transmitting terminal polarization-codes it and transmits it on a quantum channel, and (2) a process in which a receiving terminal measures it using a basis pair and verifies the security through QBER estimation, and restores message information after the security is confirmed, and a more specific operation order will be described below.

### Message Transmission and Measurement Method

Hereinafter, (1) a method for minimizing an information loss occurring during a process of transmitting and measuring information transmitted through a single photon, and (2) a method for blocking a possibility of eavesdropping on message information transmitted on a quantum channel are proposed. First, in (1) the method for minimizing the information loss occurring during the process of transmitting and measuring the information transmitted through the single photon, (i) a transmitting terminal generates the same type of single photon pair and transmits them on separate quantum channels, and (ii) a receiving terminal measures the photon pair transmitted on the quantum channels using a method of randomly selecting two combinations of Mutually Unbias Basis. Through the above process, a measurement loss at the receiving terminal can be eliminated. If the transmitting terminal performs polarization coding on classical information using a single photon pair and then transmits quantum information, on which the polarization coding is performed, on a quantum channel, there is a possibility that message information included in the quantum information may be intercepted by an eavesdropper. Accordingly, a method of scrambling or encrypting classical message information is proposed to block the possibility of eavesdropping on the message information transmitted on the quantum channel. A scrambling method of randomly scrambling the message information or a method of encrypting a message using the existing encryption technique is used. Hence, even if the eavesdropper intercepts information transmitted on the quantum channel before determining whether there is eavesdropping, the eavesdropper is prevented from being able to obtain meaningful message information from only the intercepted information.

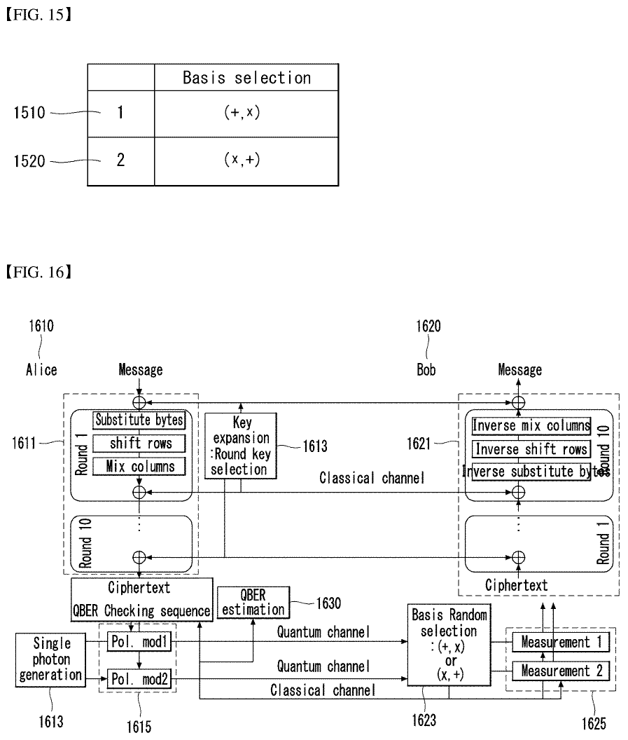

For a more detailed description, referring to FIG. 14, a transmitting terminal (Alice) may generate four types of message photon pairs consisting of pairs of the same polarization component. A polarization pair of 0 degree and 45 degrees may represent classical information 0, and a polarization pair of 90 degrees and 135 degrees may represent classical information 1. Conversely, the photon pairs may be configured such that the polarization pair of 0 degree and 45 degrees represents the classical information 1, and the polarization pair of 90 degrees and 135 degrees represents the classical information 0. In this instance, a transmitting device with the parallel structure for message transmission may be configured such that a single photon generator of the transmitting terminal produces a single photon pair having a polarization of 0 degree, and polarization modulators 1 and 2 of the transmitting terminal generate a single photon pair corresponding to one basis of two types of basis to be used for message information coding and a classical information value (bit value) of the message information. For example, the transmitting terminal may perform polarization coding on the classical information including a plurality of bits. Here the classical information including the plurality of bits may be one in which scrambling or encryption is applied to a hybrid sequence including message information and a checking sequence randomly inserted between the message information. Here, when the transmitting terminal applies polarization coding to one bit of the plurality of bits with a bit value ‘0’ that is the message information, the transmitting terminal may select one basis of + basis and × basis. If the transmitting terminal selects the + basis, a bit value of the one bit that is the message information is ‘0’, so the one bit may be polarization-coded with a polarization pair of 0 degree. Conversely, if the transmitting terminal selects the × basis, a bit value of the one bit that is the message information is ‘0’, so the one bit may be polarization-coded with a polarization pair of 45 degrees. Subsequently, the transmitting terminal may simultaneously transmit quantum information based on the classical information including the plurality of polarization-coded bits to the receiving terminal through two quantum channels, and the receiving terminal may randomly select a combination of Mutually Unbias Basis for measuring the quantum information in each of the two quantum channels. FIG. 15 illustrates an example of a measurement basis pair used for measurement of a single photon pair. Referring to FIG. 15, it can be seen that two types of measurement basis pairs are defined for measurement of the receiving terminal for the quantum information transmitted from the transmitting terminal. That is, a measurement basis pair in the form of (+, ×) or (×, +) may be defined for the measurement of the receiving terminal, and the receiving terminal may select one basis pair of two basis pairs for the measurement. In this instance, in the case of the measurement of the receiving terminal for one bit, which is the message information, having the bit value of ‘0’, when the receiving terminal selects a combination of Mutually Unbias Basis in the form of (+ basis, × basis), the one bit, which is the message information, having the bit value of ‘0’ has been polarization-coded through a polarization pair corresponding to the + basis at the transmitting terminal. Therefore, a correct value is measured on one of the two quantum channels on which the receiving terminal performs the measurement using the + basis. The correct value is not measured on one of the two quantum channels on which the receiving terminal performs the measurement using the × basis. As described above, the transmitting terminal uses a polarization pair polarized with the same polarization component for polarization coding, and the receiving terminal uses a combination of Mutually Unbias Basis to measure polarization-coded information. Hence, a correct measurement value can be obtained on at least one of the two quantum channels, and the measurement loss at the receiving terminal can be eliminated. In addition, the transmitting terminal performs the scrambling or encryption on the classical information to be polarization-coded before performing the polarization coding, and thus can eliminate the possibility that the message information included in the quantum information can be intercepted by the eavesdropper.

A scrambling method and an encryption method for eliminating the possibility that message information included in quantum information can be intercepted by an eavesdropper are described in detail below.

### (Proposal 1—Method of Enhancing Security of Message Information Through Scrambling)

A first method to prevent an eavesdropper from obtaining message information from information transmitted on a quantum channel even if the eavesdropper intercepts the information is to scramble the message information using a binary sequence obtained from a true random number generator, such as a quantum random number generator (QRNG), and an XOR operation and then transmit it. If information of a random number sequence generated through the XOR operation between the message information and a true random number with the same length as the message information is transmitted on the quantum channel, the eavesdropper can intercept the information of the random number sequence. However, since the intercepted information is only the random number sequence not the message information, it is impossible for the eavesdropper to obtain meaningful message information from the intercepted information. The security of transmission information can be enhanced through the above method. Information actually transmitted from a transmitting terminal to a receiving terminal can be generated based on Equation below.

$$Actual transmission information = ( message sequence ) XOR ( true random number sequence ) \qquad [ Equation 3 ]$$

After transmission information (to which the polarization coding is applied) is transmitted from the transmitting terminal to the receiving terminal on the quantum channel, only when the security of the transmission information is confirmed through QBER estimation between the transmitting terminal and the receiving terminal, the transmitting terminal transmits information on the random number sequence combined with the message information to the receiving terminal on the classical channel. Subsequently, the receiving terminal restores the message information prior to scrambling based on a measured value of the random number sequence measured by the receiving terminal and the information on the random number sequence. More specifically, the receiving terminal performs the XOR operation on the measured value of the random number sequence measured by the receiving terminal and the random number sequence used for scrambling at the transmitting terminal included in the information on the random number sequence to restore the message information prior to scrambling.

The message restoration at the receiving terminal can be performed based on Equation below.

$$Restoration message = ( measured random number sequence ) XOR ( true random number sequence ) \qquad [ Equation 4 ]$$

### (Proposal 2—Method of Enhancing Security of Message Information Through Encryption)

In addition to the method of applying scrambling to ensure the security of message information transmitted by a transmitting terminal, encryption technology such as AES or PQC can be applied. More specifically, in the present proposal, (1) the transmitting terminal may encrypt a message using the encryption technology such as AES or PQC and transmit it, and (2) a receiving terminal may measure encrypted information and pass the measured encrypted information through a reverse process of the encryption performed by the transmitting terminal to restore the original message information.

FIG. 16 illustrates an example of a security enhancement method of message information through encryption. More specifically, FIG. 16 illustrates an example of a photon-pair based one-way and one-step QDC method in which AES technology is used as an encryption technology for message encryption. Referring to FIG. 16, in order to enhance security of message information through encryption, a transmitting terminal 1610 needs to have an encryption part 1611, and a receiving terminal 1620 needs to have a decryption part 1621 in advance. In addition, in order to ensure absolute security of the message information, before security of encrypted information transmitted on a quantum channel is secured through a QBER estimation 1630, round key information formed in a key expansion unit 1613 is possessed only by the transmitting terminal 1610, and after the security of the encrypted information transmitted on the quantum channel is secured through the QBER estimation 1630, the transmitting terminal 1610 may share the round key information with the receiving terminal 1620 on a classical channel. Through the method describe above, the security of a message can be guaranteed even if the message information (transmission information) is eavesdropped by an eavesdropper. In FIG. 16, the transmitting terminal 1610 generates a single photon pair for polarization coding in a single photon generator 1613. Then, the transmitting terminal 1610 performs encryption on the message information 1611. In this instance, the encryption may be repeatedly performed through several steps, and the round key generated in the key expansion unit 1613 may be used for encryption in each encryption step that is repeatedly performed. FIG. 16 illustrates an example in which the encryption process is repeated 10 times, but the methods proposed in the present disclosure are not limited thereto. The encrypted message information is generated through an encryption process 1611, and transmission information including the encrypted message information and a checking sequence for the QBER estimation is generated. In this instance, the transmission information may be configured in a form in which the checking sequence is randomly inserted between sequence elements of the encrypted message information. Subsequently, the transmitting terminal 1610 performs a polarization coding 1615 on the transmission information to generate quantum information and transmits the generated quantum information to the receiving terminal 1620. In this instance, an operation for the transmitting terminal 1610 to transmit the generated quantum information to the receiving terminal 1620 may also be understood as an operation for the transmitting terminal 1610 to transmit a photon pair. Subsequently, the receiving terminal 1620 measures the quantum information transmitted from the transmitting terminal 1610, and in this case, the receiving terminal 1620 selects one of the two measurement basis pairs 1510 and 1520 described above with reference to FIG. 15 to perform the measurement. Subsequently, the transmitting terminal 1610 transmits, to the receiving terminal 1620, information on a position of the checking sequence used for the QBER estimation. In this instance, the transmitting terminal 1610 and the receiving terminal 1620 may share basis information used for polarization coding/measurement with each other. That is, only a measurement value corresponding to a position of a bit sequence used for polarization coding/measurement with the same basis in the transmitting terminal and the receiving terminal is used as the measurement (reception) information of the receiving terminal 1620. Based on the information on the location, the receiving terminal 1620 transmits, to the transmitting terminal 1610, a measurement result including information on the bit values measured using the same basis as the basis used for polarization coding in the transmitting terminal 1610 among bit values included in measured result information. If the transmitting terminal 1610 performs the QBER estimation 1630 and determines that there is an eavesdropper, the transmitting terminal 1610 does not perform any additional operation. On the contrary, if it is determined that there is no eavesdropper, the transmitting terminal 1610 transmits additional information necessary for decrypting the encrypted message information to the receiving terminal 1620. Subsequently, the receiving terminal 1620 decrypts (1621) the measured encrypted information by performing the reverse process of the encryption in the transmitting terminal 1610 using the additional information.

### QBER Estimation Process

In a one-way and one-step QDC transmission method proposed in the present disclosure, since information is transmitted using a single-photon pair, if only single photon information of the same state is paired and transmitted on a quantum channel, there is a possibility that an eavesdropper can continuously attempt to eavesdrop on the same photon information that constitutes the photon pair. To block the possibility of eavesdropping due to this, unlike the message transmission process that uses only combinations of the four same polarization states, the present disclosure applies polarization coding based on 16 photon pair combinations, which are all possible photon pair combinations, to a checking sequence for QBER estimation, thereby detecting an eavesdropper's attempt to eavesdrop on photon signals of the same polarization state.

FIG. 17 illustrates an example of a photon pair combination defined for polarization coding for a checking sequence for QBER estimation. Referring to FIG. 17, photon pairs for polarization coding for a checking sequence for QBER estimation include (i) photon pairs 1710 constructed based on polarization components of the same basis and (ii) photon pairs 1720 constructed based on polarization components of different basises.

(i) The photon pairs 1710 constructed based on polarization components of the same basis are first described. The photon pairs 1710 includes (a) four photon pairs 1711 including the same polarization component of the same basis and (b) four photon pairs 1713 including different polarization components of the same basis. In (b) the photon pairs 1713 including different polarization components of the same basis, if two single photons constituting each of the photon pairs 1713 include the same polarization component and the order of including the two single photons in each photon pair 1713 is different in the four photon pairs 1713, the four photon pairs 1713 may be different photon pairs. That is, when there are two photon pairs consisting of a zero-degree single photon and a 90-degree single photon, a photon pair consisting of the zero-degree single photon and the 90-degree single photon in the order named and a photon pair consisting of the 90-degree single photon and the zero-degree single photon in the order named may be different photon pairs.

Next, (ii) the photon pairs 1720 constructed based on polarization components of different basises are described. The photon pairs 1720 may be configured such that if one of two single photons included in the photon pair is a single photon of × basis, the other single photon of the two single photons includes a single photon of + basis. Further, if two single photons constituting each of the photon pairs 1721 and 1723 include the same polarization component and the order of including the two single photons in each of the photon pairs 1721 and 1723 is different in the photon pairs 1721 and 1723, the photon pairs 1721 and 1723 may be different photon pairs. That is, when there are two photon pairs consisting of a zero-degree single photon and a 45-degree single photon, a photon pair consisting of the zero-degree single photon and the 45-degree single photon in the order named and a photon pair consisting of the 45-degree single photon and the zero-degree single photon in the order named may be different photon pairs.

A detailed process of a QBER estimation operation performed between the transmitting terminal and the receiving terminal is described below.

The transmitting terminal generates a checking sequence to be used for QBER estimation together with message information. In this instance, the checking sequence is randomly combined and transmitted together with the message information. In this instance, polarization coding is applied to the checking sequence generated in the transmitting terminal based on 16 types of single-photon pairs, and the single-photon pair based on the polarization coding is transmitted on a quantum channel. When a bit value of the checking sequence is “01”, if a polarization pair constructed based on the same basis is used for the polarization coding of the checking sequence, a photon pair consisting of a zero-degree single photon and a 90-degree single photon or a photon pair consisting of a 45-degree single photon and a 135-degree single photon may be used. Alternatively, if a polarization pair constructed based on different basises is used for the polarization coding of the checking sequence, a photon pair consisting of a zero-degree single photon and a 135-degree single photon or a photon pair consisting of a 45-degree single photon and a 90-degree single photon may be used. Configuring transmission information in the form of randomly inserting the checking sequence into a message information sequence can prevent the occurrence of a case in which the transmitting terminal and the receiving terminal cannot check whether there is eavesdropping through QBER estimation due to an eavesdropper attempting to eavesdrop by avoiding only a location of information used for QBER estimation. For example, if the transmission information is configured in the form of concatenating the checking sequence for QBER estimation to a last bit of the message information sequence, the eavesdropper may attempt to eavesdrop on the transmission information and stop eavesdropping only on the transmission information corresponding to the position of the checking sequence. Hence, even if the QBER estimation is performed, the eavesdropper's eavesdropping may not be detected. However, if the transmission information is configured in the form of randomly inserting the checking sequence for QBER estimation into the message information sequence, the eavesdropper cannot determine where the checking sequence for QBER estimation exists in a sequence column of the transmission information, and thus it is impossible to stop eavesdropping only at the position corresponding to the checking sequence.

Next, the transmitting terminal transmits, to the receiving terminal, location information of the checking sequence transmitted for the QBER estimation on a classical channel.

Subsequently, the receiving terminal transmits a measurement value at a location indicated by the location information and basis information used for the measurement to the transmitting terminal on the classical channel.

The transmitting terminal compares values of information generated by the transmitting terminal with values measured by the receiving terminal with respect to values of bit positions where the same basis is used in the transmitting terminal and the receiving terminal, and calculates a ratio of bit values that do not match each other among bit values of all bit positions where the same basis is used in the transmitting terminal and the receiving terminal, thereby estimating the QBER. If a QBER estimation value exceeds a reference threshold for determining whether there is eavesdropping, it is determined that an eavesdropper is present. Hence, the transmitting terminal does not transmit, on the classical channel, information for restoring the scrambled or encrypted message information transmitted to the receiving terminal, and stops the entire transmission process. On the contrary, if the QBER estimation value is less than or equal to the reference threshold for determining whether there is eavesdropping, it is determined that the eavesdropper is not present. Hence, the transmitting terminal transmits, to the receiving terminal, additional information for restoring the message information transmitted on the quantum channel using the classical channel.

In addition, if the QBER estimation value is less than or equal to the reference threshold for determining whether there is eavesdropping, but the QBER estimation value is not zero, there may also be a possibility that an error has occurred in the message information. For example, when the QBER estimation value is 5%, if a total length of the message information is 100 bits, there is a possibility that an error has occurred in five bits out of the total 100 bits. In this case, the transmitting terminal and the receiving terminal may additionally perform a procedure for correcting the error.

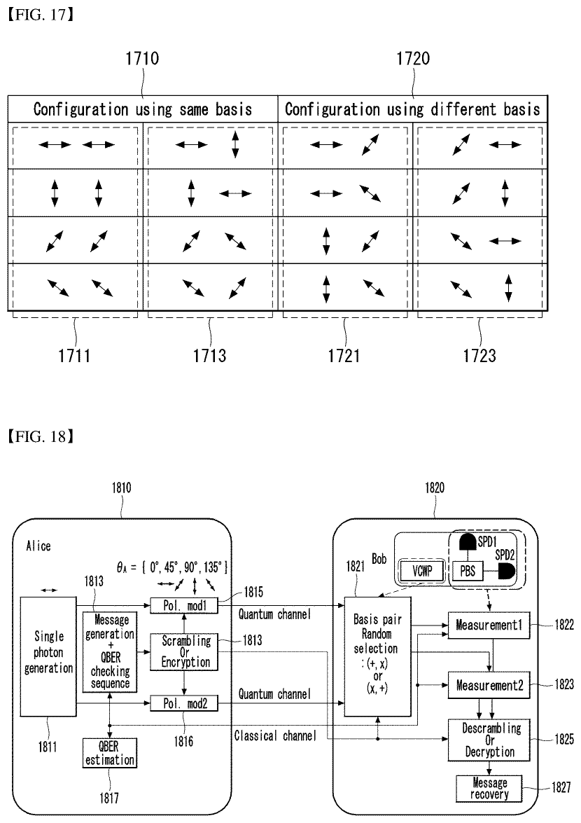

The above-described contents are described with reference to FIG. 18. FIG. 18 illustrates an overall configuration of a single-photon pair based QDC protocol with a parallel structure. Referring to FIG. 18, a transmitting terminal 1810 generates a single photon pair for polarization coding in a single photon generator 1811. The transmitting terminal 1810 generates a message information sequence and a checking sequence for QBER estimation, and generates a hybrid transmission information sequence by randomly combining the message information sequence and the checking sequence for QBER estimation. Subsequently, the transmitting terminal 1810 performs scrambling or encryption on the hybrid transmission information sequence (1819). In this instance, the scrambling or the encryption may be performed on only the message information sequence included in the hybrid transmission information sequence. Subsequently, the transmitting terminal 1810 performs polarization coding (1815 and 1816) on the transmission information to generate quantum information and transmits the generated quantum information to the receiving terminal 1820. In this instance, an operation for the transmitting terminal 1810 to transmit the generated quantum information to the receiving terminal 1820 may also be understood as an operation for the transmitting terminal 1810 to transmit a photon pair. Subsequently, the receiving terminal 1820 measures (1822 and 1823) the quantum information transmitted from the transmitting terminal 1810, and in this case, the receiving terminal 1820 selects (1821) one of the two measurement basis pairs (1510 and 1520) described above with reference to FIG. 15 to perform the measurement. Subsequently, the transmitting terminal 1810 transmits, to the receiving terminal 1820, information on a position of the checking sequence used for QBER estimation. In this instance, the transmitting terminal 1810 and the receiving terminal 1820 may share basis information used for polarization coding/measurement with each other. That is, only a measurement value corresponding to a position of a bit sequence used for polarization coding/measurement with the same basis in the transmitting terminal and the receiving terminal is used as measurement (reception) information of the receiving terminal 1820. Based on the information on the position, the receiving terminal 1820 transmits, to the transmitting terminal 1810, a measurement result including information on the bit values measured using the same basis as the basis used for polarization coding in the transmitting terminal 1810 among bit values included in measured result information. If the transmitting terminal 1810 performs the QBER estimation 1817 and determines that there is an eavesdropper, the transmitting terminal 1810 does not perform any additional operation. On the contrary, if it is determined that there is no eavesdropper, the transmitting terminal 1810 transmits additional information necessary for decrypting the scrambled or encrypted message information to the receiving terminal 1820. Subsequently, the receiving terminal 1820 decrypts (1825 and 1827) the measured encrypted information by performing a reverse process of the encryption in the transmitting terminal 1810 using the additional information.

### Device Configuration Method

The following describes a method for device configuration for implementing a one-way and one-step QDC method based on a parallel structure.

A device for implementing a one-way and one-step QDC method based on a parallel structure may be configured through two methods. More specifically, the transmitting terminal includes a single-photon generator using a laser light source and a polarization modulator used for polarization information coding, and a device of the receiving terminal may be configured in two ways.

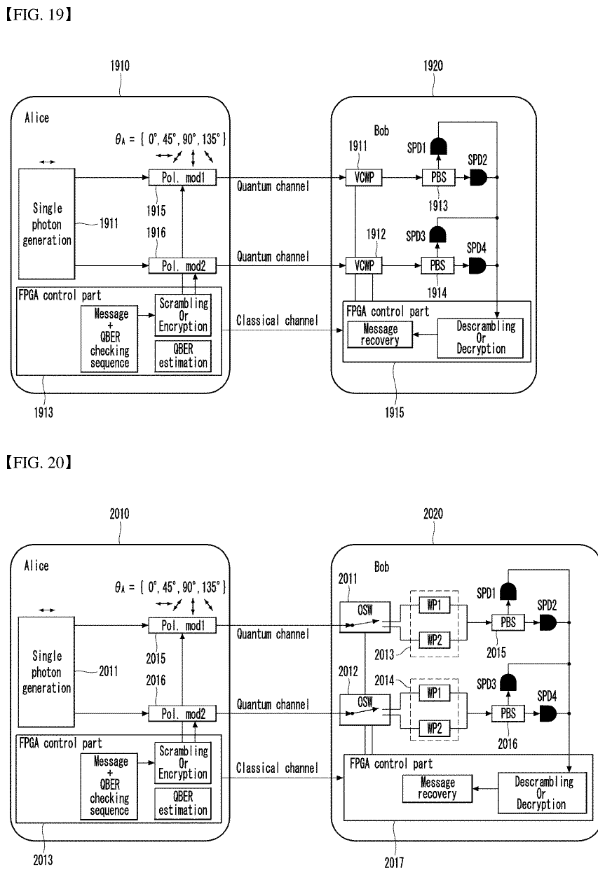

FIG. 19 illustrates an example of device configuration for implementing a one-way and one-step QDC method based on a parallel structure. Referring to FIG. 19, a transmitting terminal 1910 may include a single-photon generator 1911 using a laser light source, an FPGA controller 1913 that generates message information and a checking sequence for QBER estimation and performs scrambling or encryption and the QBER estimation on the generated sequence, and polarization modulators 1915 and 1916 used for polarization information coding. A receiving terminal 1920 includes two voltage-controlled wave plates (VCWPs) 1911 and 1912 for measurement basis selection of a received single-photon pair. In this instance, each of the VCWPs 1911 and 1912 is controlled through an electrical signal based on a basis selected in each path. One of the two VCWPs 1911 and 1912 passes a polarization state of the input photon as it is, and the other VCWP rotates the input polarization state by 45 degrees and allows the photon pair received by the receiving terminal 1920 from the transmitting terminal 1910 to be measured using different basises. A photon signal measured based on each of the different basises passes polarized beam splitters (PBS) 1913 and 1914, and then a received value is determined depending on a measuring position of a single photon detector (SPD). For example, when measured at SPD 1, a measurement value may be 0, when measured at SPD 2, the measurement value may be 1, and vice versa. Also, the same manner may be applied to SPD 3 and SPD 4. In addition, the receiving terminal 1920 includes an FPGA controller 1915 that descrambles or decrypts the signal received from the transmitting terminal 1910 and restores the message information.

FIG. 20 illustrates another example of device configuration for implementing a one-way and one-step QDC method based on a parallel structure. In FIG. 20, a measurement method at a receiving terminal 2020 is different from the measurement method at the receiving terminal 1920 of FIG. 19, and the remaining parts are the same as the method of FIG. 19. The example of FIG. 20 describes only the difference from the method of FIG. 19. A photon pair received from a measurement unit of the receiving terminal 2020 is connected to either WP (wave plate) 1 or WP2 (2013 or 2014) depending on which of two measurement basises to be measured by optical switches (OSWs) 2011 and 2012. Since the photon pair is transmitted on two quantum channels, the two OSWs are used, and the two OSWs are connected through different paths so as to measure the photon pair received on the two quantum channels in different basises. For example, in FIG. 20, when the OSW 2011 is connected to the WP1(2) (2013), the OSW 2012 is connected to the WP2(1) (2014). Here, the WP1 and the WP2 (2013 and 20214) serve as two different basises. Further, the WP1 may correspond to an orthogonal basis, and the WP2 may correspond to a diagonal basis. Since the WP1 is the orthogonal basis, it passes a polarization state of the input polarized photon without changing the polarization, and since the WP2 is the diagonal basis, it rotates a polarization state of the input polarized photon by 45 degrees.

### Serial Structure

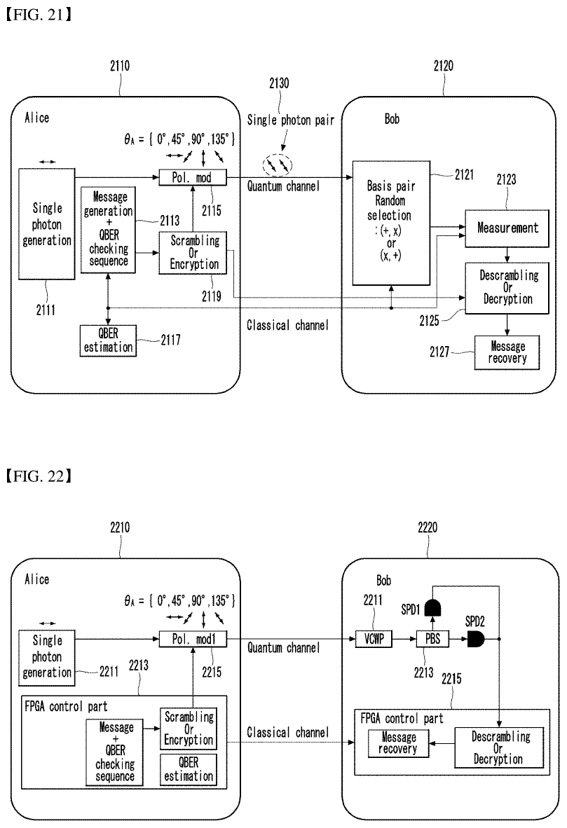

A single-photon pair based QDC protocol based on a serial structure is described below with reference to FIG. 21. FIG. 21 illustrates an overall configuration of a single-photon pair based QDC protocol with a serial structure. Referring to FIG. 21, unlike the single-photon pair based QDC protocol based on the parallel structure described above, in the single-photon pair based QDC protocol based on the serial structure, a transmitting terminal 2110 transmits, on a single quantum channel, two single-photon light sources generated sequentially when generating a signal of a single-photon pair. Therefore, the QDC protocol based on the serial structure requires only half the number of components compared to the QDC protocol based on the parallel structure: a polarization modulator used to generate signals of a single photon pair, a voltage controlled wave plate (VCWP) used for basis comparison, a PBS used by a receiving terminal 2120 to measure a quantum signal (photon pair) transmitted from the transmitting terminal 2110, and a single photon detector. As a result, the complexity of the configuration of the transmitting terminal 2110 and the receiving terminal 2120 can be reduced. On the other hand, since two photons must be sequentially transmitted on the single quantum channel to transmit 1 bit of classical information (2130), a length of an information block used by the transmitting terminal 2110 to transmit the same amount of message may be twice as long as in the parallel structure in which two photons are transmitted simultaneously on two quantum channels. Further, in a process of selecting a basis pair during a process of measuring the received signal by the receiving terminal 2120, unlike the parallel structure in which the receiving terminal measures signals simultaneously transmitted on two quantum channels using two different basises, in the serial structure, the receiving terminal 2120 continuously receives signals of a photon pair of the same polarization state through a single path. Therefore, in the transmitted photon pair, a basis used for measuring information first received and a basis used for measuring information next received can be selected differently, and hence, at least one of two consecutive signals constituting the photon pair can be measured in the same basis as the signal transmitted from the transmitting terminal 2110. In addition, (2) a single photon generator 2111, message information generation and QBER checking sequence generation (2113), QBER estimation (2117), and message scrambling or encryption (2119) at the transmitting terminal 2110, and (2) descrambling or decryption (2125) and message restoration (2127) at the receiving terminal 2120 in the serial structure are the same as those in the parallel structure, and thus a description thereof can be equally applied to the contents described in FIG. 18.

### Device Configuration Method

The following describes a method for device configuration for implementing a one-way and one-step QDC method based on a serial structure. A device in the one-way and one-step QDC method based on the serial structure may be configured through two methods depending on how a measurement basis is selected at a receiving terminal, in the same manner as the one-way and one-step QDC method based on the parallel structure.

FIG. 22 illustrates an example of device configuration for implementing a one-way and one-step QDC method based on a serial structure. Referring to FIG. 22, a transmitting terminal 2210 may include a single-photon generator 2211 using a laser light source, an FPGA controller 2213 that generates message information and a checking sequence for QBER estimation and performs scrambling or encryption and the QBER estimation on the generated sequence, and a polarization modulator 2215 used for polarization information coding.

A receiving terminal 2220 includes a voltage-controlled wave plate (VCWP) 2211 for measurement basis selection of a received single-photon pair. Since each of signals of a photon pair transmitted on a single quantum channel is received at a different time in the VCWP 2211, the VCWP 2211 can change a polarization state of the input signal so that a first received signal and a next received signal among the signals of the photon pair can be measured based on different basises. A photon signal measured based on the different basis in the VCWP 2211 passes a polarized beam splitter (PBS) 2213, and then a received value is determined depending on a measuring position of a single photon detector (SPD). For example, when measured at SPD 1, a measurement value may be 0, when measured at SPD 2, the measurement value may be 1, and vice versa. In addition, the receiving terminal 2220 includes an FPGA controller 2215 that descrambles or decrypts the signal received from the transmitting terminal 2210 and restores the message information.

FIG. 23 illustrates another example of device configuration for implementing a one-way and one-step QDC method based on a serial structure. In FIG. 23, a measurement method at a receiving terminal 2320 is different from the measurement method at the receiving terminal 2210 of FIG. 22, and the remaining parts are the same as the method of FIG. 22. The example of FIG. 23 describes only the difference from the method of FIG. 22. A photon pair received from a measurement unit of the receiving terminal 2320 is measured at an optical switch (OSW) 2311. Since the photon pair is transmitted on one quantum channel, one OSW is used. In this instance, when two signals constituting the photon pair are sequentially transmitted on the quantum channel and are received by the receiving terminal 2320, the OSW 2311 specifies paths of the two signals so that the two signals are measured in different basises. More specifically, if a signal that is first received among the two signals is transmitted to WP1 (2313), the signal is measured in an orthogonal basis. Therefore, a signal that is later received among the two signals is transmitted to WP2 and is measured in a diagonal basis. As a result, the successively received signals of the photon pair are not measured in the same basis. Alternatively, if a signal that is first received among the two signals is transmitted to WP2 (2313), the signal is measured in the diagonal basis. Therefore, a signal that is later received among the two signals is transmitted to WP1 and is measured in the orthogonal basis. As a result, the successively received signals of the photon pair are not measured in the same basis.

### Expected Effect

A result of verifying expected effects of the method described in the present disclosure is described below. The present disclosure proposes a method of minimizing a distance loss (0.2 dB/km) that occurs when information is stored in an optical fiber-based quantum memory for a long time more than three times the time it takes to pass through the channel, even after the information is transmitted through a single photon on a quantum channel in the existing QDC method. Through the method described in the present disclosure, a loss rate of transmitted message information can be significantly reduced compared to the existing QDC method based on the same distance transmission.

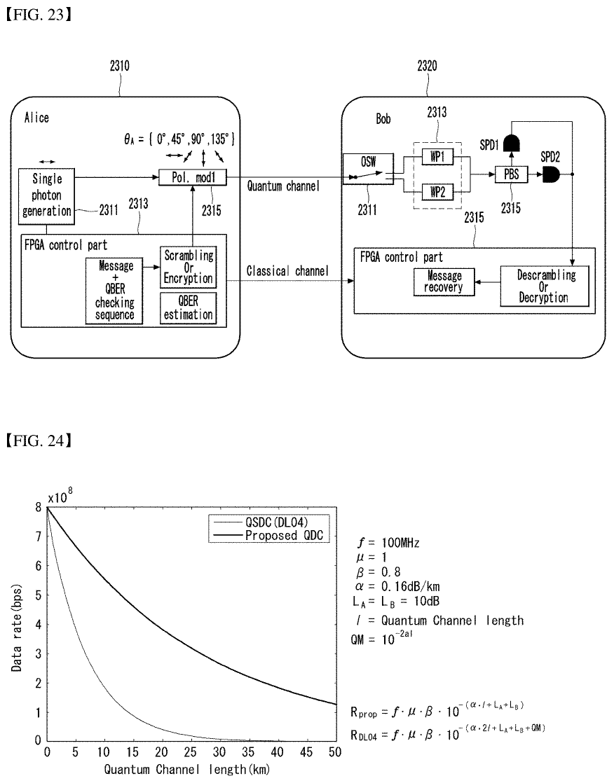

FIG. 24 illustrates expected effects in a QDC method described in the present disclosure. More specifically, FIG. 24 illustrates a result of comparing a data rate when a transmitter in the DL04 protocol that is a QDC technique with an existing single-photon based round-trip structure and a transmitter in the method described in the present disclosure generate signals under the same conditions and transmit the signals over the same distance. In FIG. 24, main parameters used for the comparison between the method described in the present disclosure and the existing QDC technique are as below.

### Main Parameters

f: repetition rate
μ: Mean photon number
β: Detection efficiency of SNSPD
α: fiber loss
L_{A}, L_{B}: system loss of Alice and Bob side
QM: fiber based quantum memory loss
R_{DL04}; data rate of DL04
Rₚᵣₒₚ; data rate of proposed method

While the existing technique passes the quantum channel twice and stores photon in a quantum memory for twice a channel passage time, the technique according to the present disclosure passes the quantum channel once and does not use the quantum memory to thereby obtain the effect of reducing a distance loss. That is, when the transmitter of each of the method described in the present disclosure and the existing QDC technique generates photon signals at the same repetition rate, the distance loss of the method described in the present disclosure is reduced to less than four times that of a transmission distance of the existing QDC technique. Therefore, it can be expected to have the effect of increasing the transmission distance by an average of four times more at the same data rate compared to the existing QDC technique. For example, the existing QDC technique has a transmission speed of 2 Mbps at a transmission distance of 10 km, but the method described in the present disclosure can have the same data rate as the existing QDC technique at a transmission distance of 40 km.

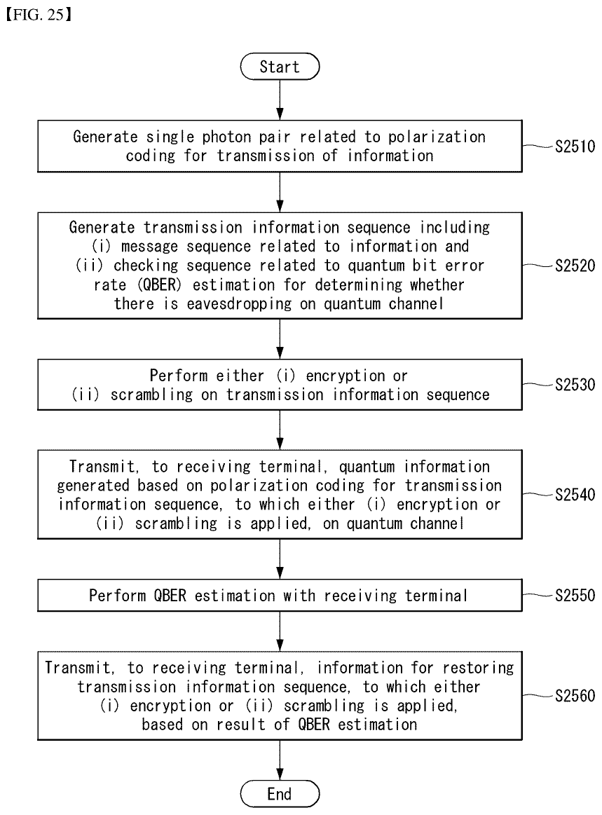

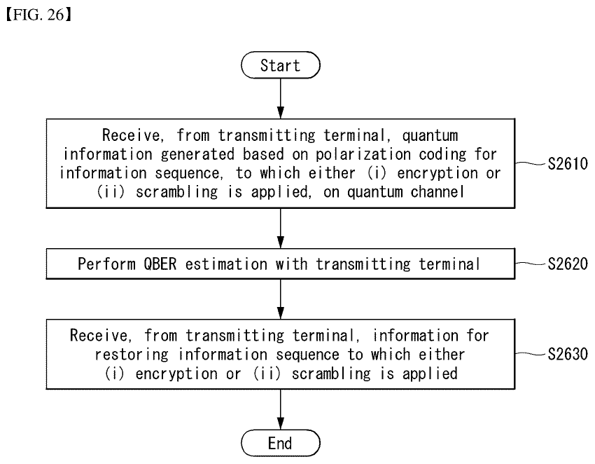

FIG. 25 is a flowchart illustrating an example in which a method of transmitting information in a quantum communication system described in the present disclosure is performed by a transmitting terminal.

A transmitting terminal generates a single photon pair related to a polarization coding for transmission of information, in S2510.

Next, the transmitting terminal generates a transmission information sequence including (i) a message sequence related to the information and (ii) a checking sequence related to a quantum bit error rate (QBER) estimation for determining whether there is eavesdropping on a quantum channel, in S2520.

The checking sequence is randomly inserted between sequence elements of the message sequence.

Next, the transmitting terminal performs either (i) an encryption or (ii) a scrambling on the transmission information sequence, in S2530.

Next, the transmitting terminal transmits, to a receiving terminal, quantum information generated based on the polarization coding for the transmission information sequence, to which either (i) the encryption or (ii) the scrambling is applied, on the quantum channel, in S2540.

Next, the transmitting terminal performs the QBER estimation with the receiving terminal, in S2550.

Finally, the transmitting terminal transmits, to the receiving terminal, information for restoring the transmission information sequence, to which either (i) the encryption or (ii) the scrambling is applied, based on a result of the QBER estimation, in S2560.

FIG. 26 is a flowchart illustrating an example in which a method of transmitting information in a quantum communication system described in the present disclosure is performed by a receiving terminal.

A receiving terminal receives, from a transmitting terminal, a single photon pair including quantum information generated based on a polarization coding for an information sequence, to which either (i) an encryption or (ii) a scrambling is applied, on a quantum channel through a basis pair including different basises, in S2610.

The polarization coding is performed based on the single photon pair for the polarization coding. The information sequence includes (i) a message sequence related to the information and (ii) a checking sequence related to a quantum bit error rate (QBER) estimation for determining whether there is eavesdropping on the quantum channel. The checking sequence is randomly inserted between sequence elements of the message sequence.

Next, the receiving terminal performs the QBER estimation with the transmitting terminal, in S2620.

Next, the receiving terminal receives, from the transmitting terminal, information for restoring the information sequence, to which either (i) the encryption or (ii) the scrambling is applied, based on a result of the QBER estimation, in S2630.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by subsequent amendment after the application is filed.

The embodiments of the present disclosure may be achieved by various means, for example, hardware, firmware, software, or a combination thereof. In a hardware configuration, the methods according to the embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present disclosure may be implemented in the form of a module, a procedure, a function, etc. For example, software code may be stored in a memory unit and executed by a processor. The memories may be located at the interior or exterior of the processors and may transmit data to and receive data from the processors via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL AVAILABILITY

The present disclosure has been described focusing on examples applying to 3GPP LTE/LTE-A, the 5G system, and the quantum communication system, but can be applied to various wired/wireless communication systems in addition to 3GPP LTE/LTE-A, the 5G system, and the quantum communication system.

1. A method comprising:
generating, by a transmitting terminal, a single photon pair related to a polarization coding for transmission of information;
generating, by the transmitting terminal, a transmission information sequence including (i) a message sequence related to the information and (ii) a checking sequence related to a quantum bit error rate (QBER) estimation for detecting eavesdropping on a quantum channel,
wherein the checking sequence is randomly inserted between sequence elements of the message sequence;
performing, by the transmitting terminal, either (i) an encryption or (ii) a scrambling on the information sequence;
transmitting, to a receiving terminal, quantum information generated based on the polarization coding for the information sequence, to which either (i) the encryption or (ii) the scrambling is applied, on the quantum channel;
performing, by the transmitting terminal, the QBER estimation with the receiving terminal; and
transmitting, to the receiving terminal, information for restoring the information sequence, to which either (i) the encryption or (ii) the scrambling is applied, based on a result of the QBER estimation.

2. The method of claim 1, wherein, based on a value of the result of the QBER estimation being greater than or equal to a specific value, the information for restoring the information sequence is not transmitted.

3. The method of claim 1, wherein, based on a value of the result of the QBER estimation being less than a specific value, the information for restoring the information sequence is transmitted.

4. The method of claim 3, wherein the scrambling is performed through an XOR operation between the information sequence and a sequence generated from a random number generator.

5. The method of claim 4, wherein, based on the scrambling being applied to the information sequence, the information for restoring the information sequence includes information for the sequence generated from the random number generator.

6. The method of claim 5, wherein, based on the scrambling being applied to the information sequence, the information sequence to which the scrambling is applied is restored through an XOR operation between a sequence measured at the receiving terminal and a sequence included in the information for the sequence generated from the random number generator.

7. The method of claim 3, wherein the encryption is performed based on (i) a symmetric key pre-shared between the transmitting terminal and the receiving terminal and (ii) a round key configured to only the transmitting terminal.

8. The method of claim 7, wherein, based on the encryption being applied to the information sequence, the information for restoring the information sequence includes information onfor the round key.

9. The method of claim 8, wherein, based on the encryption being applied to the information sequence, the information sequence to which the encryption is applied is restored by performing a reverse process of the encryption performed by the transmitting terminal through the information for the round key with respect to a sequence measured at the receiving terminal.

10. The method of claim 1, wherein different polarization codings are used for (i) the message sequence related to the information and (ii) the checking sequence related to the QBER estimation.

11. The method of claim 10, wherein the polarization coding used for the message sequence related to the information is performed based on different two types of basises and different four types of single photon pairs,
wherein each of the two types of basises is constructed based on two types of single photons classified based on an angle that a single photon has, and
wherein each of the four types of single photon pairs includes (i) the same type of basis and (ii) the same type of two single photons among two types of single photons constituting the same type of basis.

12. The method of claim 10, wherein the polarization coding used for the checking sequence related to the QBER estimation is performed based on different two types of basises and different 16 types of single photon pairs,
wherein each of the two types of basises is constructed based on two types of single photons classified based on an angle that a single photon has, and
wherein the 16 types of single photon pairs include:
(a) (i) the same type of basis and (ii) four single photon pairs including the same type of two single photons among two types of single photons constituting the same type of basis; and
(b) (i) the same type of basis and (ii) four single photon pairs including different types of two single photons among two types of single photons constituting the same type of basis.

13. The method of claim 12, wherein the 16 types of single photon pairs further include eight single photon pairs including two single photons included in different types of basises.

14. The method of claim 13, wherein, based on types of two single photons constituting each of two single photon pairs being the same, and an order of including the two single photons in each of the two single photon pairs being different in the two single photon pairs, the two single photon pairs are different single photon pairs.

15. A transmitting terminal comprising:
a transmitter configured to transmit a radio signal;
a receiver configured to receive the radio signal;
at least one processor; and
at least one computer memory operably connectable to the at least one processor and configured to store instructions performing operations based on being executed by the at least one processor,
wherein the operations comprise:
generating a single photon pair related to a polarization coding for transmission of information;
generating a transmission information sequence including (i) a message sequence related to the information and (ii) a checking sequence related to a quantum bit error rate (QBER) estimation for detecting eavesdropping on a quantum channel,
wherein the checking sequence is randomly inserted between sequence elements of the message sequence;
performing either (i) an encryption or (ii) a scrambling on the information sequence;
transmitting, to a receiving terminal, quantum information generated based on the polarization coding for the information sequence, to which either (i) the encryption or (ii) the scrambling is applied, on the quantum channel;
performing the QBER estimation with the receiving terminal; and
transmitting, to the receiving terminal, information for restoring the information sequence, to which either (i) the encryption or (ii) the scrambling is applied, based on a result of the QBER estimation.

16. (canceled)

17. A receiving terminal comprising:
a transmitter configured to transmit a radio signal;
a receiver configured to receive the radio signal;
at least one processor; and
at least one computer memory operably connectable to the at least one processor and configured to store instructions performing operations based on being executed by the at least one processor,
wherein the operations comprise:
receiving, from a transmitting terminal, a single photon pair including quantum information generated based on a polarization coding for an information sequence, to which either (i) an encryption or (ii) a scrambling is applied, on a quantum channel through a basis pair including different basises,
wherein the polarization coding is performed based on the single photon pair for the polarization coding,
wherein the information sequence includes (i) a message sequence related to the information and (ii) a checking sequence related to a quantum bit error rate (QBER) estimation for detecting eavesdropping on the quantum channel,
wherein the checking sequence is randomly inserted between sequence elements of the message sequence;
performing the QBER estimation with the transmitting terminal; and
receiving, from the transmitting terminal, information for restoring the information sequence, to which either (i) the encryption or (ii) the scrambling is applied, based on a result of the QBER estimation.

18.-19. (canceled)
